(19) United States
(12) Patent Application Publication
(10) Pub. No.: US 2014/0052542 A1
(43) Pub. Date: Feb. 20, 2014

(54) METHOD, CLIENT AND SYSTEM FOR RECOMMENDING SOFTWARE

(71) Applicant: Tencent Technology (Shenzhen) Company Limited, Shenzhen (CN)

(72) Inventors: Ru ZHANG, Shenzhen (CN); Xing ZENG, Shenzhen (CN)

(73) Assignee: Tencent Technology (Shenzhen) Company Limited, Shenzhen (CN)

(21) Appl. No.: 14/010,463

(22) Filed: Aug. 26, 2013

Related U.S. Application Data
(63) Continuation of application No. PCT/CN2013/080753, filed on Aug. 2, 2013.

(30) Foreign Application Priority Data
Aug. 15, 2012 (CN) 201210290376.1

(51) Int. Cl. G06Q 30/02

(52) U.S. Cl. CPC G06Q 30/0269
USPC 705/14.66; 705/14.73

(57) ABSTRACT

An electronic device with one or more processors, memory, and a display obtains, from a server, a software recommendation notification, where the software recommendation notification at least comprises a name of recommended software. The device also displays, on the display, the software recommendation notification in a notification bar, where the notification bar is in a peripheral region of the display. The device: detects a first user interaction with the software recommendation notification; and upon detecting the first user interaction with the software recommendation notification, displays descriptive information corresponding to the recommended software.

### RELATED APPLICATIONS AND PRIORITY CLAIMS

This application is a continuation application of PCT Patent Application No. PCT/CN2013/080753, entitled “METHOD, CLIENT, AND SYSTEM FOR RECOMMENDING SOFTWARE”, filed on Aug. 2, 2013, which claims priority to Chinese Patent Application No. 201210290376.1, entitled “METHOD, CLIENT, AND SYSTEM FOR RECOMMENDING SOFTWARE,” filed on Aug. 15, 2012, both of which are incorporated herein by reference in their entireties.

### TECHNICAL FIELD

The disclosed implementations relate generally to the field of computer technologies, and in particular, to a method, a client, and a system for recommending software.

### BACKGROUND

With the development of software technologies, increasingly more software is developed and applied, which greatly enriches and facilitates people's lives. Meanwhile, how a user selects software that is needed and interests the user from a large quantity of software has become a problem. In the prior art, a client device runs software, obtains, from a server, recommended software, and displays the recommended software at an advertisement position or, alternatively, the recommended software is marked with a recommendation identifier. In this way, a user is enabled to select software that is needed and interests the user from recommended software displayed at the advertisement position or software identified by the recommendation identifier.

During the implementation of the present invention, the inventors find that the prior art has at least the following problems: If a client needs to run software, the client can obtain recommended software from a server only after the Internet is connected, so that a manner of obtaining the recommended software is passive and is not timely enough. In addition, the recommended software is presented by means of an advertisement position or a recommendation identifier, as a result, the presentation manner is not visually distinct.

### SUMMARY

In order to solve the problems in the prior art, embodiments of the present invention provide a method, a client, and a system for recommending software. The technical solutions are described as follows. In one aspect, an embodiment of the present invention provides a method of recommending software. In some embodiments, the method is performed at a client device with one or more processors, memory, and a display (e.g., client device 702/703, FIGS. 7-8). The method includes receiving a software recommendation notification sent by a server, where the software recommendation notification at least includes a name of software recommended by the server. The method also includes: displaying the software recommendation notification in a notification bar; and when a request for viewing the software recommended by the server in the software recommendation notification is received, displaying description information of the recommended software that is requested to be viewed. In some embodiments, the description information includes one or more of an icon of the software, the name of the software, a version number of the software, the size of the software, a function introduction of the software, a download address of the software, and developer information of the software.

In another aspect, an embodiment of the present invention further provides a client (e.g., client device 702/702, FIGS. 7-8), where the client includes: a receiving module; a first display control module; and a second display control module. The receiving module is configured to receive a software recommendation notification sent by a server, where the software recommendation notification at least includes a name of software recommended by the server. The first display control module is configured to display the software recommendation notification in a notification bar. The second display control module is configured to: when a request for viewing the software recommended by the server in the software recommendation notification is received, display description information of the recommended software that is requested to be viewed. In some embodiments, the description information includes one or more of an icon of the software, the name of the software, a version number of the software, the size of the software, a function introduction of the software, a download address of the software, and developer information of the software.

In still another aspect, an embodiment of the present invention further provides a system for recommending software, where the system includes a server (e.g., server system 710, FIGS. 7 and 9) and a client (e.g., client device 702/703, FIGS. 7-8). The server is configured to send a software recommendation notification to the client, where the software recommendation notification at least includes a name of software recommended by the server. The client is configured to receive the software recommendation notification sent by the server, and display the software recommendation notification in a notification bar. The client is further configured to: when receiving a request for viewing the software recommended by the server in the software recommendation notification, display description information of the recommended software that is requested to be viewed. In some embodiments, the description information includes one or more of an icon of the software, the name of the software, a version number of the software, the size of the software, a function introduction of the software, a download address of the software, and developer information of the software.

Beneficial effects of the technical solutions provided by the embodiments of the present invention are described as follows: Through the implementation of the technical solution of receiving a software notification message sent by a server, and displaying the software recommendation notification in a notification bar, where the software recommendation notification at least includes a name of software recommended by the server, and when a request for viewing the software recommended by the server in the software recommendation notification is received, displaying description information of the recommended software that is requested to be viewed, a user can timely know and view, through the notification bar, the software recommended by the server. As such, the manner of obtaining the recommended software is easy, convenient, and timely. In addition, for recommended software that interests the user, the user can send a view request by clicking a corresponding software recommendation notification in the notification bar. Subsequently, when the request for viewing the software recommended by the server in the software recommendation notification is received, the description information of the recommended software is displayed. Thus, the user can further understand the recommended software according to the description information after knowing, through the notification bar, the software recommended by the server, so as to determine whether to download the recommended software, thereby improving the user experience.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

To illustrate the technical solutions in the embodiments of the present invention more clearly, the following briefly introduces the accompanying drawings required for describing the embodiments. The accompanying drawings in the following description show merely some embodiments of the present invention, and persons of ordinary skill in the art may still derive other drawings from these accompanying drawings without undue creative efforts.

FIG. 1 is a flowchart of a method for recommending software in accordance with some embodiments.

FIG. 2 is a flowchart of a method for recommending software in accordance with some embodiments.

FIG. 3 is a structural diagram of a client in accordance with some embodiments.

FIG. 4 is a structural diagram of a client in accordance with some embodiments.

FIG. 5 is a structural diagram of a client in accordance with some embodiments.

FIG. 6 is a diagram of a system for recommending software in accordance with some embodiments.

FIG. 7 is a diagram of a client-server environment in accordance with some embodiments.

FIG. 8 is a diagram of an example of a client device in accordance with some embodiments.

FIG. 9 is a diagram of an example of a server system in accordance with some embodiments.

FIGS. 10A-10I illustrate user interfaces for recommending software in accordance with some embodiments.

FIGS. 11A-11B illustrate a flow chart of a method of recommending software in accordance with some embodiments.

FIG. 12 illustrates a flow chart of a method of recommending software in accordance with some embodiments.

### DETAILED DESCRIPTION

To make the objectives, technical solutions, and advantages of the present invention more comprehensible, the following further describes the embodiments of the present invention in detail with reference to the accompanying drawings.

### Embodiment 1

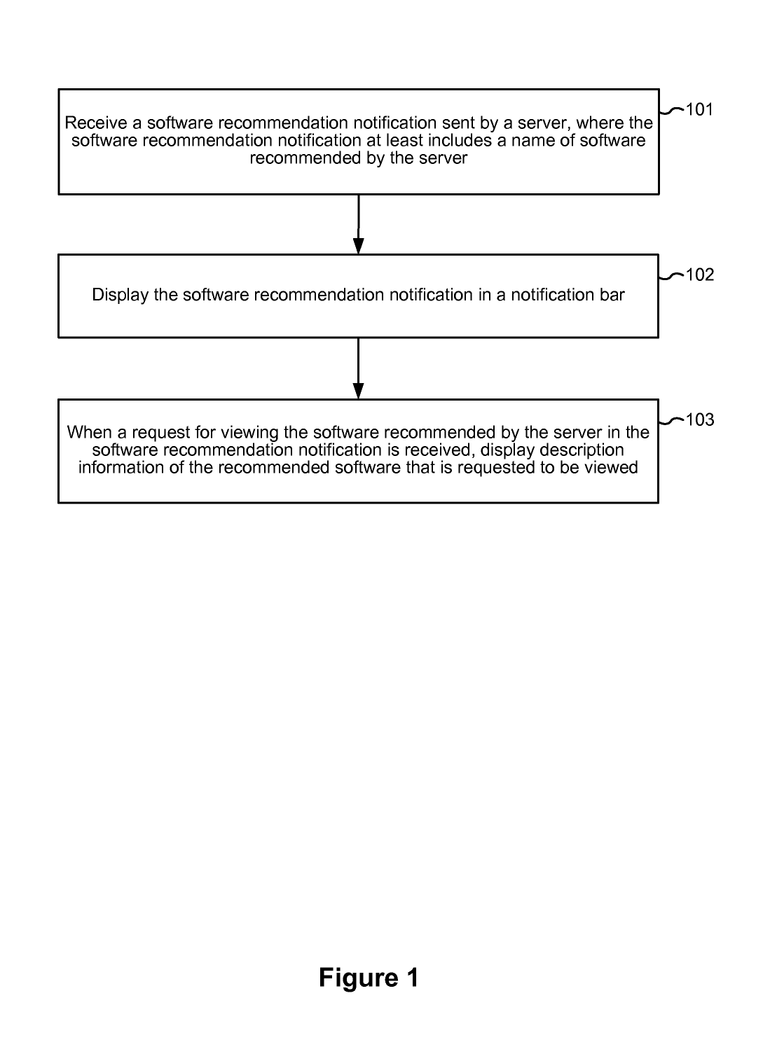

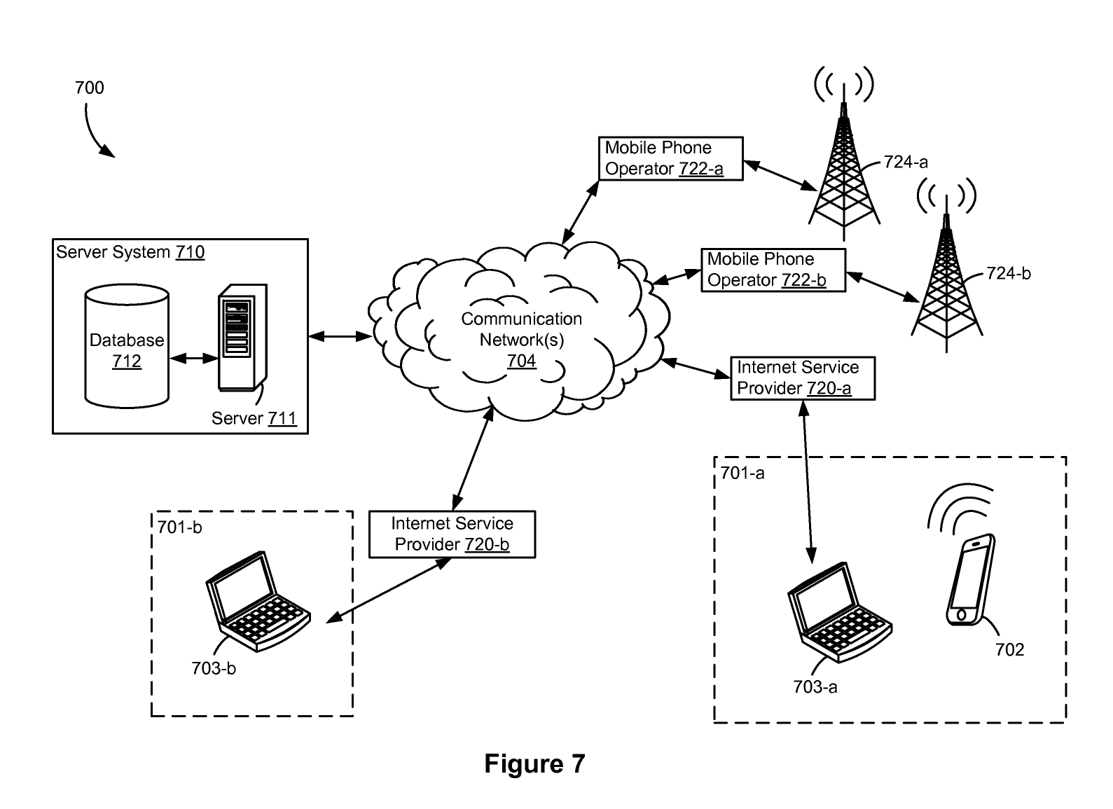

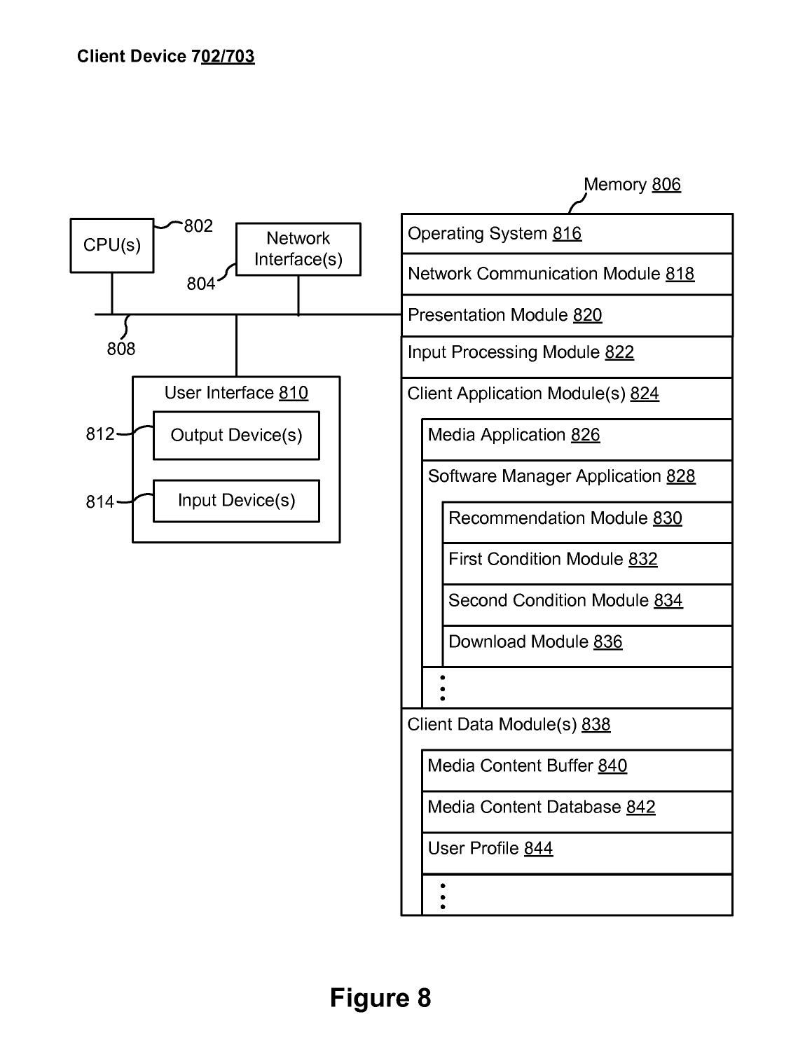

FIG. 1 illustrates a method of recommending software in accordance with some embodiments. The method illustrated in FIG. 1 is performed at an electronic device (e.g., client device 702/703, FIGS. 7-8 sometimes also herein called a client device, a client or, more simply, a device) with one or more processors, memory, and a display.

The electronic device receives (101) a software recommendation notification sent by a server (e.g., the server either pushes the software recommendation notification to the client or the client pulls the software recommendation notification from the server), where the software recommendation notification at least includes a name of recommended software.

The electronic device displays (102) the software recommendation notification in a notification bar.

When a request for viewing the software recommended by the server in the software recommendation notification is received, the electronic device displays (103) description information of the recommended software that is requested to be viewed. In some embodiments, the description information includes one or more of an icon of the software, the name of the software, a version number of the software, the size of the software, a function introduction of the software, a download address of the software, and developer information of the software.

Beneficial effects of the technical solutions provided by the embodiments of the present invention are described as follows: Through the implementation of the technical solution of receiving a software notification message sent by a server, and displaying the software recommendation notification in a notification bar, where the software recommendation notification at least includes a name of software recommended by the server, and when a request for viewing the software recommended by the server in the software recommendation notification is received, displaying description information of the recommended software that is requested to be viewed, a user can timely know and view, through the notification bar, the software recommended by the server. As such, the manner of obtaining the recommended software is easy, convenient, and timely. In addition, for recommended software that interests the user, the user can send a view request by clicking a corresponding software recommendation notification in the notification bar. Subsequently, when the request for viewing the software recommended by the server in the software recommendation notification is received, the description information of the recommended software is displayed. Thus, the user can further understand the recommended software according to the description information after knowing, through the notification bar, the software recommended by the server, so as to determine whether to download the recommended software, thereby improving the user experience.

### Embodiment 2

In an embodiment of the present invention, a server pre-configures recommended software recommended for a client. Here, the recommended software configured by the server may be popular software, where the popular software is software for which a download count and/or number of views are greater than a predetermined value for the entire network.

Furthermore, the recommended software configured by the server may also be software that conforms to a use habit of the client by customizing the recommended software according to the download behavior of the client. Here, the customized software conforming to the use habit of the client based on the software download behavior of the client includes: performing statistics, according to the software download behavior of the client or a type of software historically downloaded by the client; customizing, according to the type of the historically downloaded software that is obtained through the statistics; and/or the recommended software having the same type as the historically downloaded software. To this end, the recommended software conforms to the use habit of the client.

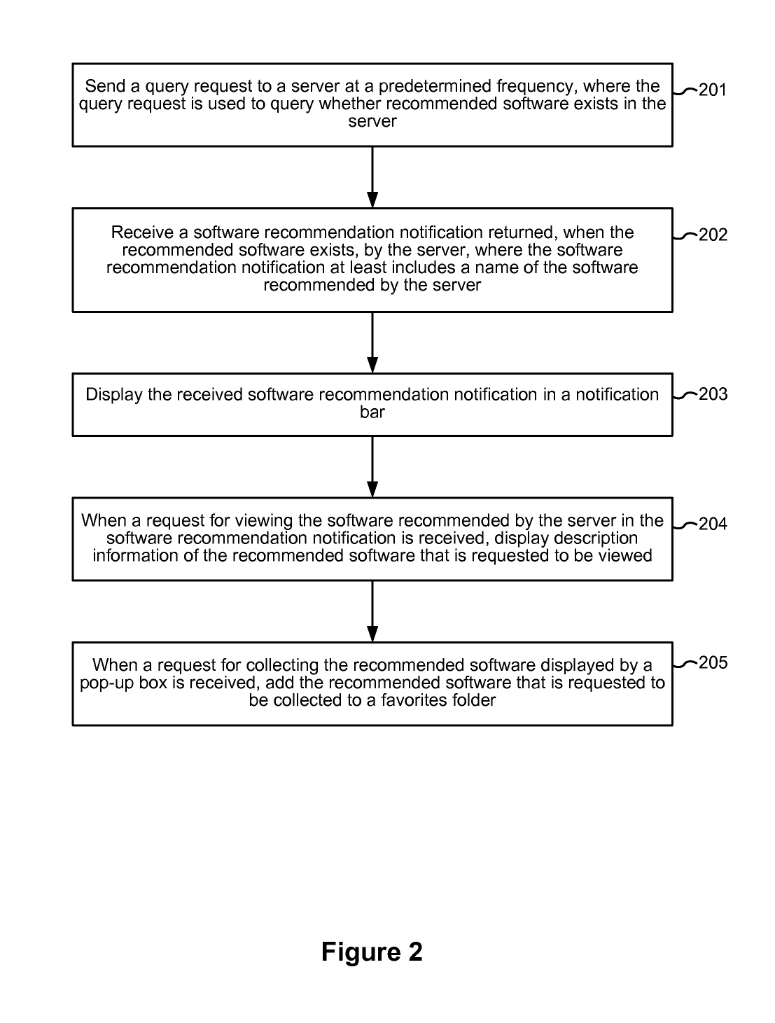

Based on the foregoing description, an embodiment of the present invention provides a method of recommending software. The method is performed by a client (e.g., client device 702/703, FIGS. 7-8 sometimes also herein referred to as an electronic device or, more simply, a device) such as a mobile phone, a tablet computer, or a computer. Furthermore, the method may be performed by a software client program such as a software manager that is built or embedded in the client. Referring to FIG. 2, the method may specifically includes the following steps:

The client sends (201) a query request to a server at a predetermined frequency, where the query request is used to query whether recommended software exists in the server. The predetermined frequency may be artificially set or may be set by software (e.g., every three hours, every one hour, or every thirty minutes) which is not limited in the embodiment of the present invention.

The client receives (202) a software recommendation notification, from the server, when the recommended software exists. The software recommendation notification at least includes a name of the software recommended by the server.

Furthermore, in the embodiment of the present invention, during specific implementation, the server may actively “push” the software recommendation notification to a client through a notification bar when the recommended software is identified by the server. The notification bar is a message push channel based on an interface of an operating system of the client, and the server may actively push the software recommendation notification to the client through the notification bar, so that step 201 and step 202 may be further replaced with and implemented by receiving the software recommendation notification actively sent by the server, when the recommended software is identified.

The client displays (203) the received software recommendation notification in a notification bar.

In this way, a user may know, through the software recommendation notification displayed by the notification bar, the software recommended by the server in a convenient and timely manner. If the user wants to further understand the recommended software notified in the software recommendation notification, the user may send a view request by clicking recommended software that interests the user in the software recommendation notification in the notification bar, so as to request to view detailed description information of the recommended software, and for details, reference may be made to step 204.

When a request for viewing the software recommended by the server in the software recommendation notification is received, the client displays (204) description information of the recommended software that is requested to be viewed. In some embodiments, the description information includes one or more of an icon of the software, the name of the software, a version number of the software, the size of the software, a function introduction of the software, a download address of the software, and developer information of the software.

In some embodiments, when the request for viewing the software recommended by the server in the software recommendation notification is received, the description information of the recommended software that is requested to be viewed is displayed through a pop-up box. It should be noted that, the pop-up box further provides a collection function, and the user may collect the recommended software, by operating a collection function option provided by the pop-up box, the software recommended by the server, and for details, reference may be made to step 205.

When a request for collecting the recommended software displayed by the pop-up box is received, the client adds (205) the recommended software that is requested to be collected to a favorites folder, so that when the software recommended by the server is needed, the client can conveniently find the recommended software that needs to be downloaded in the favorites folder and download it. In some embodiments, the client downloads the recommended software in the favorites folder in batches when a network speed meets a requirement (e.g., a download speed is greater than a predetermined value). As an example, the client downloads the software in the favorites folder in batches when WiFi or a network environment that the client is connected to meets certain bandwidth and/or speed requirements.

Beneficial effects of the technical solutions provided by the embodiments of the present invention are described as follows: Through the implementation of the technical solution of receiving a software notification message sent by a server, and displaying the software recommendation notification in a notification bar, where the software recommendation notification at least includes a name of software recommended by the server, and when a request for viewing the software recommended by the server in the software recommendation notification is received, displaying description information of the recommended software that is requested to be viewed, a user can timely know and view, through the notification bar, the software recommended by the server. As such, the manner of obtaining the recommended software is easy, convenient, and timely. In addition, for recommended software that interests the user, the user can send a view request by clicking a corresponding software recommendation notification in the notification bar. Subsequently, when the request for viewing the software recommended by the server in the software recommendation notification is received, the description information of the recommended software is displayed. Thus, the user can further understand the recommended software according to the description information after knowing, through the notification bar, the software recommended by the server, so as to determine whether to download the recommended software, thereby improving the user experience. In addition, with the collection function, the user can “bookmark” the software that he or she is interested in, and the software that has been “bookmarked” using the collection function can be downloaded automatically at an appropriate time and/or under appropriate conditions without active user supervision.

### Embodiment 3

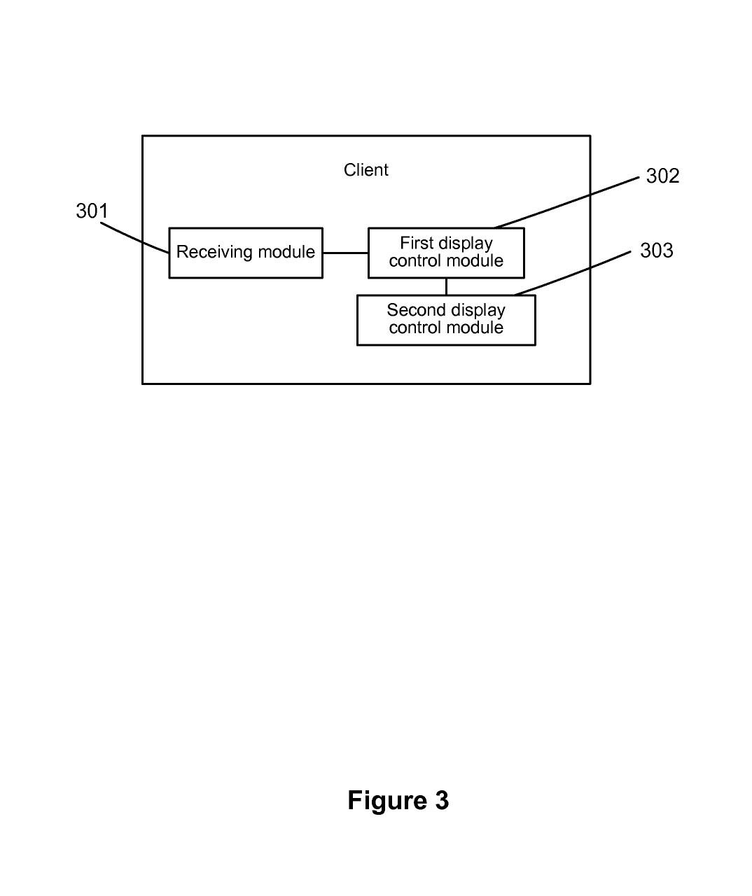

Referring to FIG. 3, an embodiment of the present invention provides a client (e.g., client device 702/70, FIGS. 7-8 sometimes also herein called an electronic device, a client, or, more simply, a device), where the client includes: a receiving module 301; a first display control module 302; and a second display control module 303.

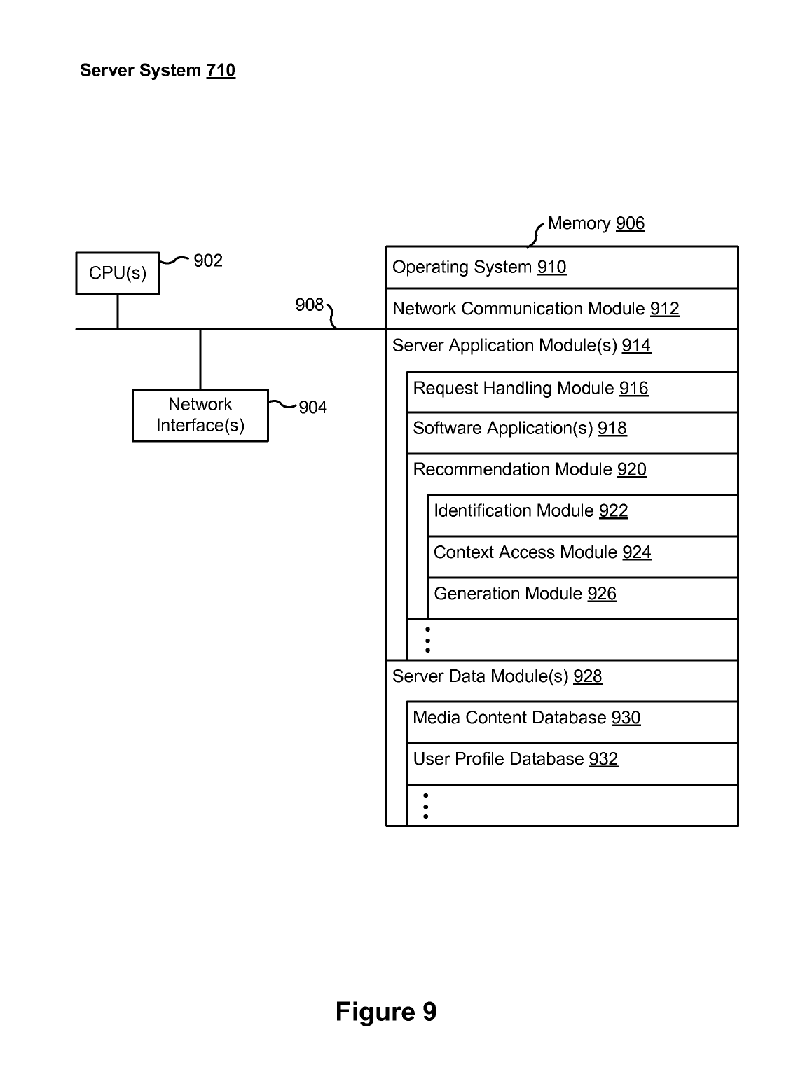

Receiving module 301 is configured to receive a software recommendation notification sent by a server (e.g., server system 710, FIGS. 7 and 9), where the software recommendation notification at least includes a name of software recommended by the server.

First display control module 302 is configured to display the software recommendation notification in a notification bar.

Second display control module 303 is configured to: when a request for viewing the software recommended by the server in the software recommendation notification is received, display description information of the recommended software that is requested to be viewed. In some embodiments, the description information includes one or more of an icon of the software, the name of the software, a version number of the software, the size of the software, a function introduction of the software, a download address of the software, and developer information of the software.

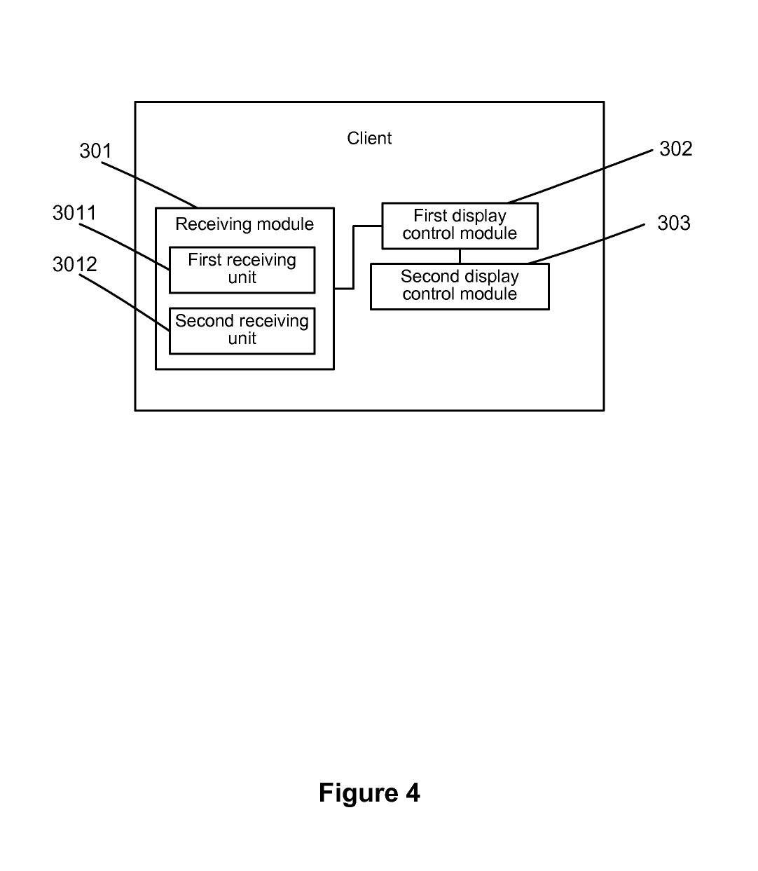

In another modified implementation manner, referring to FIG. 4, in the embodiment of the present invention, receiving module 301 in the client shown in FIG. 3 may include: a first receiving unit 3011, configured to send a query request to the server at a predetermined frequency, where the query request is used to query whether the recommended software exists in the server, and receive the software recommendation notification returned by the server, when the recommended software exists; or a second receiving unit 3012, configured to receive the software recommendation notification actively sent by the server, when the recommended software exists.

In the embodiment of the present invention, second display control module 303 shown in FIG. 3 may be specifically configured to display, through a pop-up box, the description information of the recommended software that is requested to be viewed.

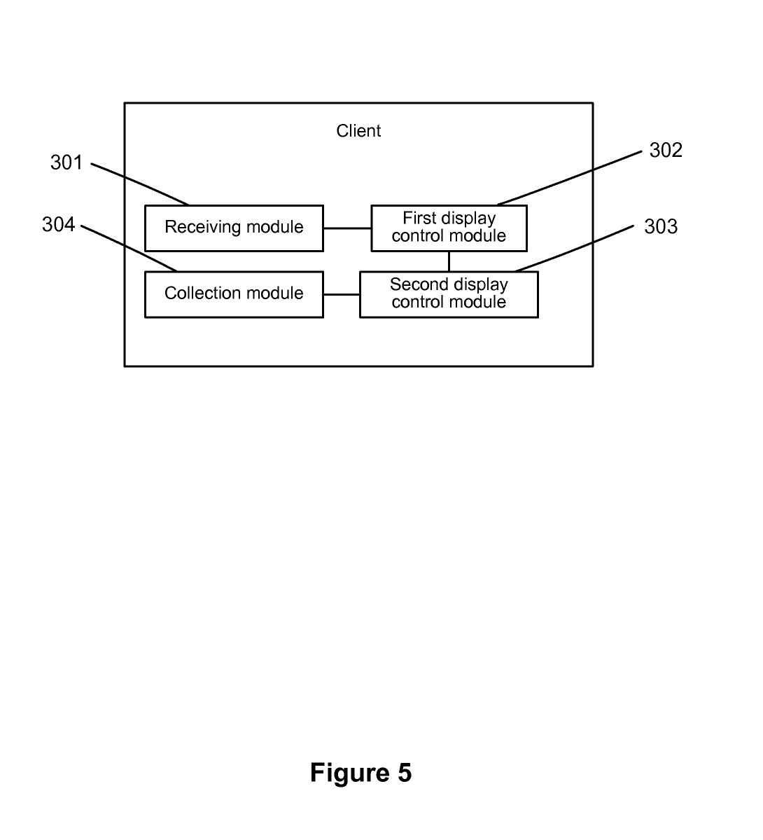

In another modified implementation, referring to FIG. 5, the client shown in FIG. 3 may further include a collection module 304, where collection module 304 is configured to: when a request for collecting the recommended software displayed by the pop-up box is received, add the recommended software that is requested to be collected to a favorites folder, so that the client downloads the recommended software in the favorites folder in batches when a network speed meets a requirement.

It should be noted that, the recommended software is popular software pre-configured by the server, or the recommended software is software that conforms to a use habit of the client and is pre-customized by the server, according to a software download behavior of the client.

Beneficial effects of the technical solutions provided by the embodiments of the present invention are described as follows: Through the implementation of the technical solution of receiving a software notification message sent by a server, and displaying the software recommendation notification in a notification bar, where the software recommendation notification at least includes a name of software recommended by the server, and when a request for viewing the software recommended by the server in the software recommendation notification is received, displaying description information of the recommended software that is requested to be viewed, a user can timely know and view, through the notification bar, the software recommended by the server. As such, the manner of obtaining the recommended software is easy, convenient, and timely. In addition, for recommended software that interests the user, the user can send a view request by clicking a corresponding software recommendation notification in the notification bar. Subsequently, when the request for viewing the software recommended by the server in the software recommendation notification is received, the description information of the recommended software is displayed. Thus, the user can further understand the recommended software according to the description information after knowing, through the notification bar, the software recommended by the server, so as to determine whether to download the recommended software, thereby improving the user experience.

### Embodiment 4

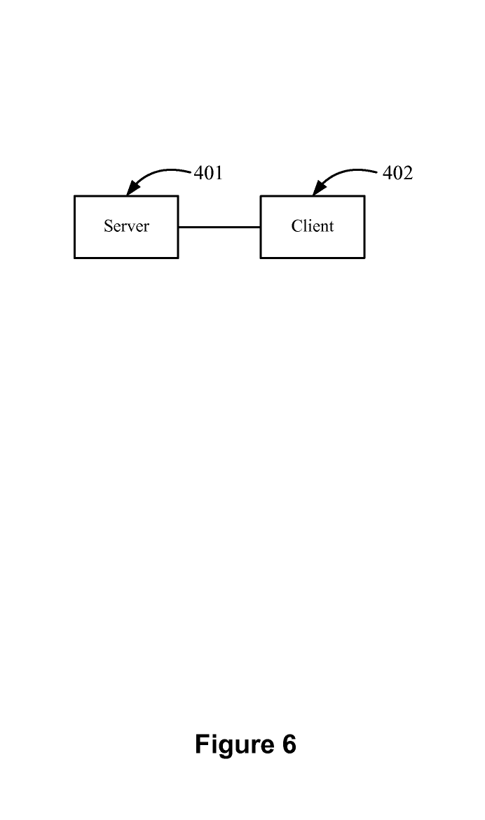

Referring to FIG. 6, an embodiment of the present invention provides a system for recommending software, where the system includes a server 401 (e.g., server system 710, FIGS. 7 and 9) and a client 402 (e.g., client device 702/703, FIGS. 7-8).

Server 401 is configured to send a software recommendation notification to client 402, where the software recommendation notification at least includes a name of software recommended by the server.

Client 402 is configured to receive the software recommendation notification sent by server 401, and display the software recommendation notification in a notification bar. Client 402 is further configured to: when receiving a request for viewing the software recommended by the server in the software recommendation notification, display description information of the recommended software that is requested to be viewed In some embodiments, the description information at least includes one or more of an icon of the software, the name of the software, a version number of the software, the size of the software, a function introduction of the software, a download address of the software, and developer information of the software.

In one embodiment, server 401 is configured to actively send the software recommendation notification to the client when the recommended software exists. In another embodiment, server 401 is configured to send the software recommendation notification to client 402 when receiving a query request from client 402 to determine whether the recommended software exists, and when the recommended software exists.

In the embodiment of the present invention, for a detailed description of the structure of the client 402, reference is made to Embodiment 3, which is not elaborated herein again.

Beneficial effects of the technical solution provided by the embodiment of the present invention are described as follows: Through the implementation of the technical solution of receiving a software notification message sent by a server, and displaying the software recommendation notification in a notification bar, where the software recommendation notification at least includes a name of software recommended by the server, and when a request for viewing the software recommended by the server in the software recommendation notification is received, displaying description information of the recommended software that is requested to be viewed, a user can timely know and view, through the notification bar, the software recommended by the server, so that an obtaining manner is easy, convenient, and timely; in addition, for recommended software that interests the user, the user can send a view request by clicking a corresponding software recommendation notification in the notification bar, and when the request for viewing the software recommended by the server in the software recommendation notification is received, the description information of the recommended software that is requested to be viewed is displayed, so that the user can further understand the recommended software according to the description information after knowing, through the notification bar, the software recommended by the server, so as to determine whether to download the recommended software, thereby improving the user experience.

It should be noted that, when the client provided by the foregoing embodiment recommends software, only an example of division of the foregoing functional modules is described for illustration, and in an actual application, the foregoing functions may be accomplished by different functional modules as required. That is, the internal structure of the client is divided into different functional modules, so as to accomplish all or a part of the functions in the foregoing description. In addition, the client provided by the foregoing embodiment belongs to the same concept as the embodiment of the method for recommending software, and for a specific implementation process, reference may be made to the method embodiment, which is not elaborated herein again.

The sequence numbers of the foregoing embodiments of the present invention are merely for description and do not represent the superiority or inferiority of the embodiments.

Persons of ordinary skill in the art may understand that, all or a part of the steps of the foregoing embodiments may be implemented through hardware, or may be implemented by a program instructing relevant hardware. The program may be stored in a computer readable storage medium. The storage medium may be a read-only memory, a magnetic disk, an optical disk, or the like.

The foregoing descriptions are merely exemplary embodiments of the present invention, but are not intended to limit the present invention. Any modification, equivalent replacement, or improvement made within the spirit and principle of the present invention shall fall within the protection scope of the present invention.

### Exemplary Client-Server Environment

FIG. 7 is a diagram of a client-server environment 700 in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, client-server environment 700 includes a server system 710, one or more mobile phone operators 722, one or more Internet service providers 720, and one or more communication networks 704. Each of server system 710, mobile phone operator 722 (e.g., a wireless carrier), and Internet service providers 720 are capable of being connected to one or more communication networks 704 in order to facilitate the exchange of information with one another and/or other devices and systems.

The exchange of information generates traffic for operators 722 which results in data usage. In some circumstances, the traffic includes messages that include a data usage value (e.g., a report of a user's data usage with a respective operator 720 or 722). Within server system 710, there is a server computer 711 for receiving and processing data received from the client devices 702 and/or 703 (e.g., for analyzing messages containing a data usage value in order to obtain a data usage value template). In some circumstances, a user 701 (e.g., a single user or a family) may have multiple client devices that share a data usage plan. For example, smart-phone 702 and laptop 703 share a mobile carrier plan with the mobile phone operator 722-b as well as an internet plan with the internet service provider 720-a. Within server system 710, there is also a database 712 for storing information (e.g., data usage templates, etc.). Additionally, mobile phone operator 722 and Internet service provider 720 are operable to connect client devices to one or more communication networks 704 as well. For example, smart-phone 702 is operable with the network of mobile phone operator 722-a, which includes for example, a base station 724-a. Similarly, for example, laptop computer 703-a (or tablet, desktop, workstation, or the like) is connectable to the network provided by first internet service provider 720-a, which is ultimately connectable to one or more communication networks 704. Laptop computer 703-b (or tablet, desktop, workstation, or the like), associated with a different user is connectable to the network provided by second internet service provider 720-b, which is ultimately connectable to one or more communication networks 704. Each of these operators (e.g., mobile phone operators 722 and Internet service providers 720), or in some cases a respective subset of the operators, place restrictions on an amount of data that a user may use (e.g., a monthly amount based on a user's data plan).

One or more communication networks 704 is any combination of wired and wireless local area network (LAN) and/or wide area network (WAN), such as an intranet, an extranet, including a portion of the Internet. In some embodiments, one or more communication networks 704 include the Internet, other Wide Area Networks, Local Area Networks, Personal Area Networks, metropolitan area networks, VPNs, local peer-to-peer and/or ad-hoc connections, and so on. It is sufficient that one or more communication networks 704 provide communication capability between client devices 702/703 and server systems 710. In some implementations, one or more communication networks 704 use HyperText Transport Protocol (HTTP) to transport information using the Transmission Control Protocol/Internet Protocol (TCP/IP). HTTP permits a client device to access various resources available via one or more communication networks 704. However, the various implementations described herein are not limited to the use of any particular protocol.

Moreover, those skilled in the art will appreciate from the present disclosure that any number of such devices and/or systems may be provided in client-server environment 700, and particular devices may be altogether absent. In other words, client-server environment 700 is merely an example provided to discuss more pertinent features of the present disclosure.

As discussed below in greater detail with reference to FIG. 8, some client devices, such as smart-phone 702 or laptop 703, include one or more input devices and one or more output devices. Herein, a respective client device 702/703 is sometimes also called a mobile terminal, an electronic device, a user device, or, more simply, a device. In operation, a client device 702/703 interact with one or more communication networks 704 and one or more hardware elements (e.g., the digital camera) to facilitate the exchange of messages that generate traffic and therefore data usage. For example, a user using smart-phone 702 takes a picture with a digital camera of the smart-phone and send the picture, with accompanying text via one or more communication networks 704 as an instant message to a distinct instant message account, or as an MMS, or as an email, which will count against the user's data plan.

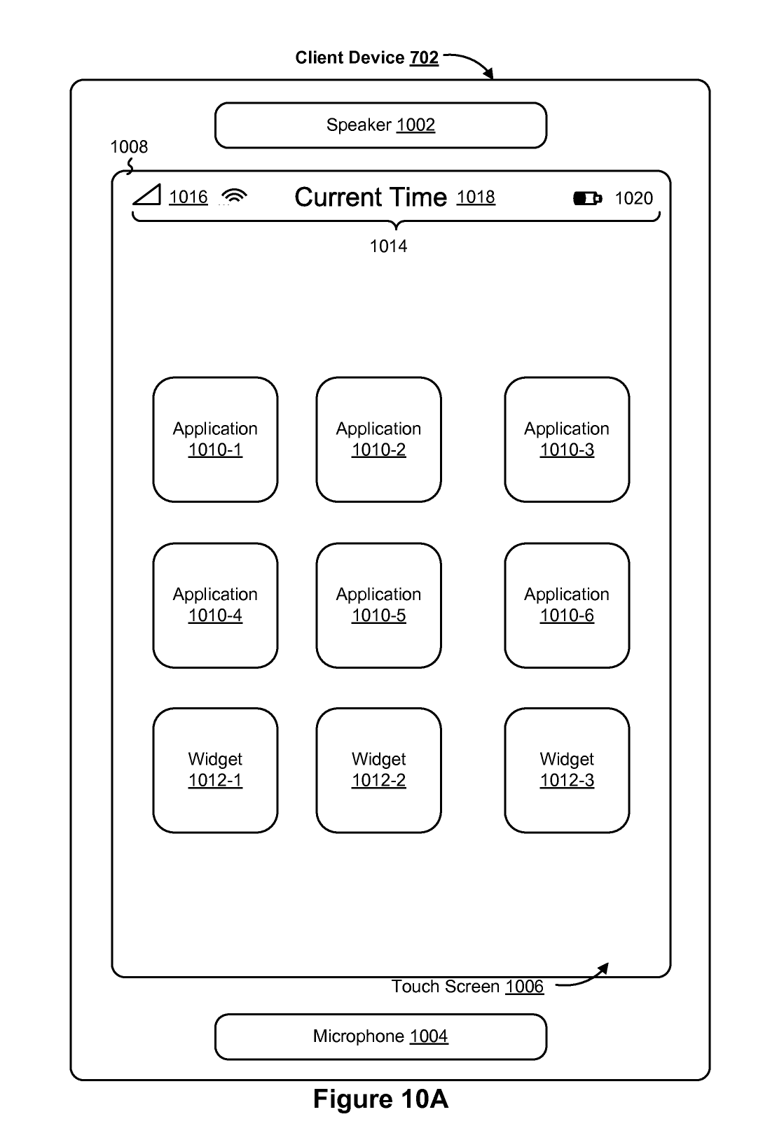

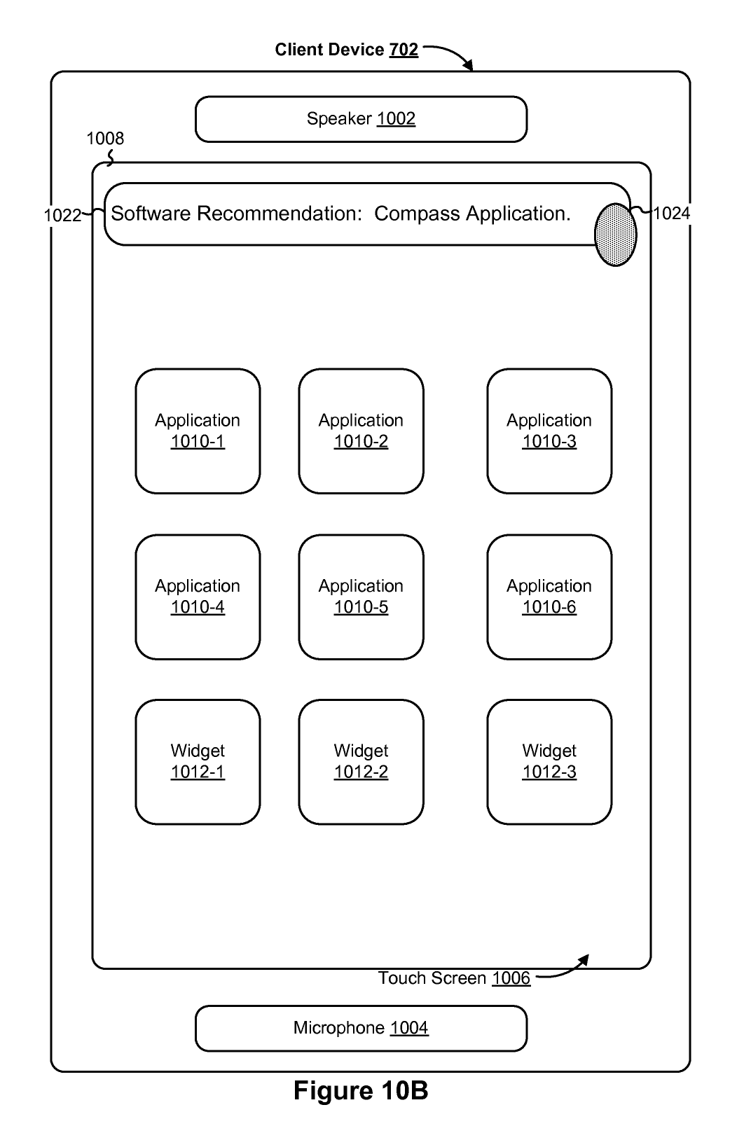

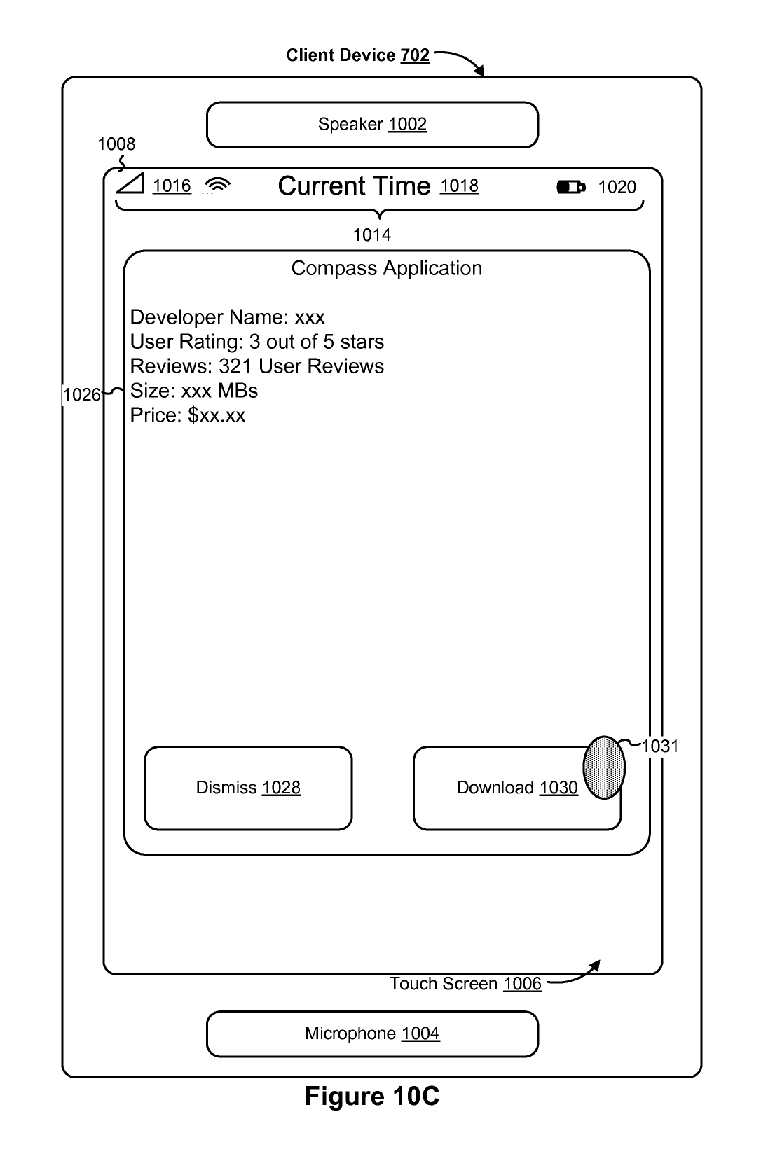

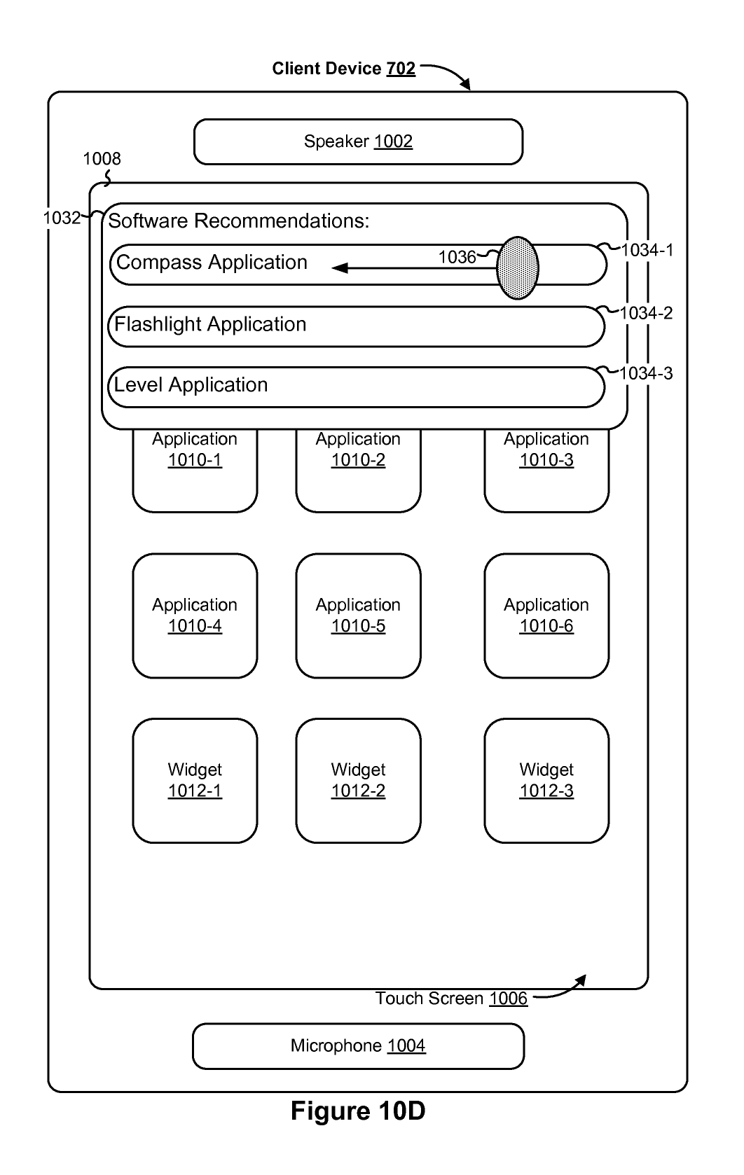

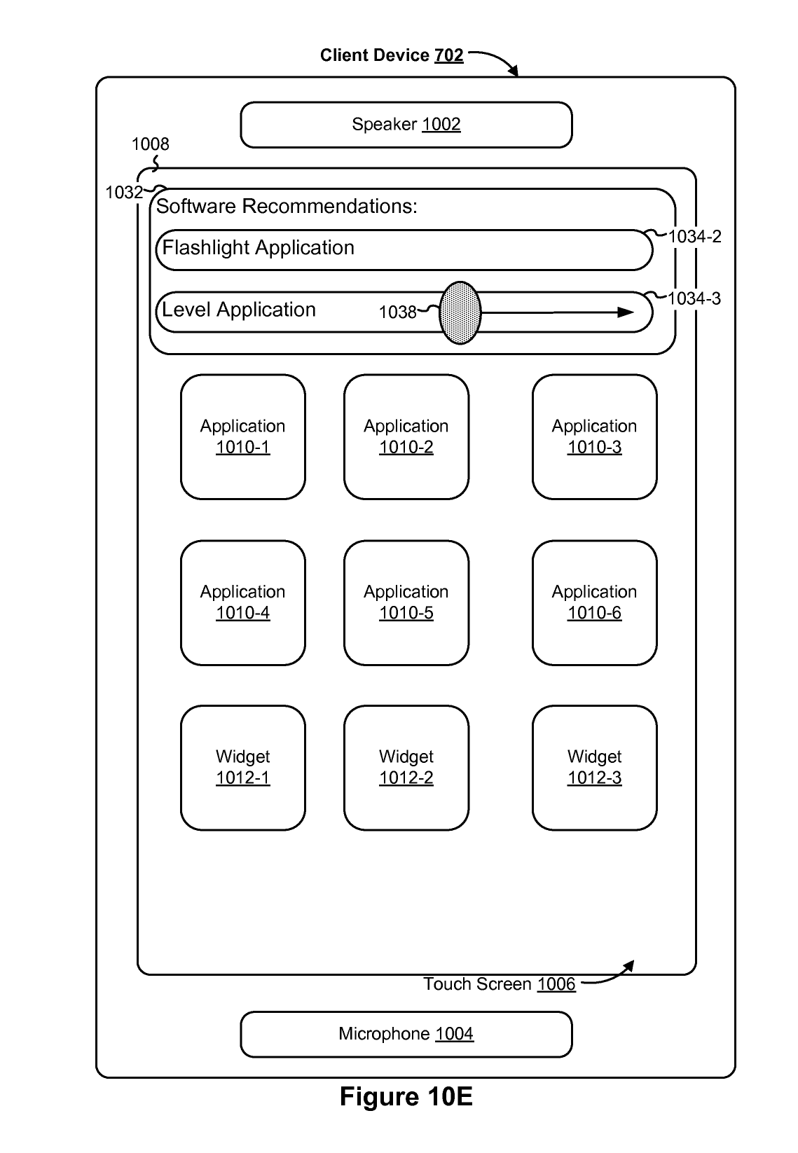

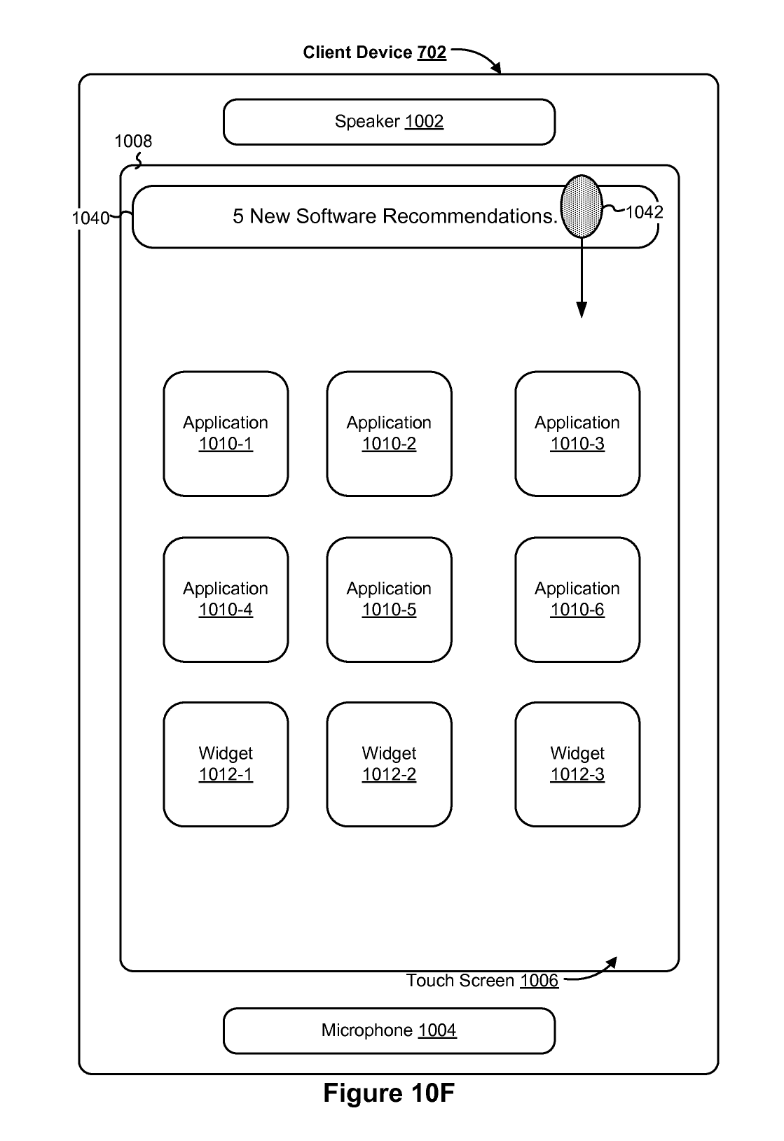

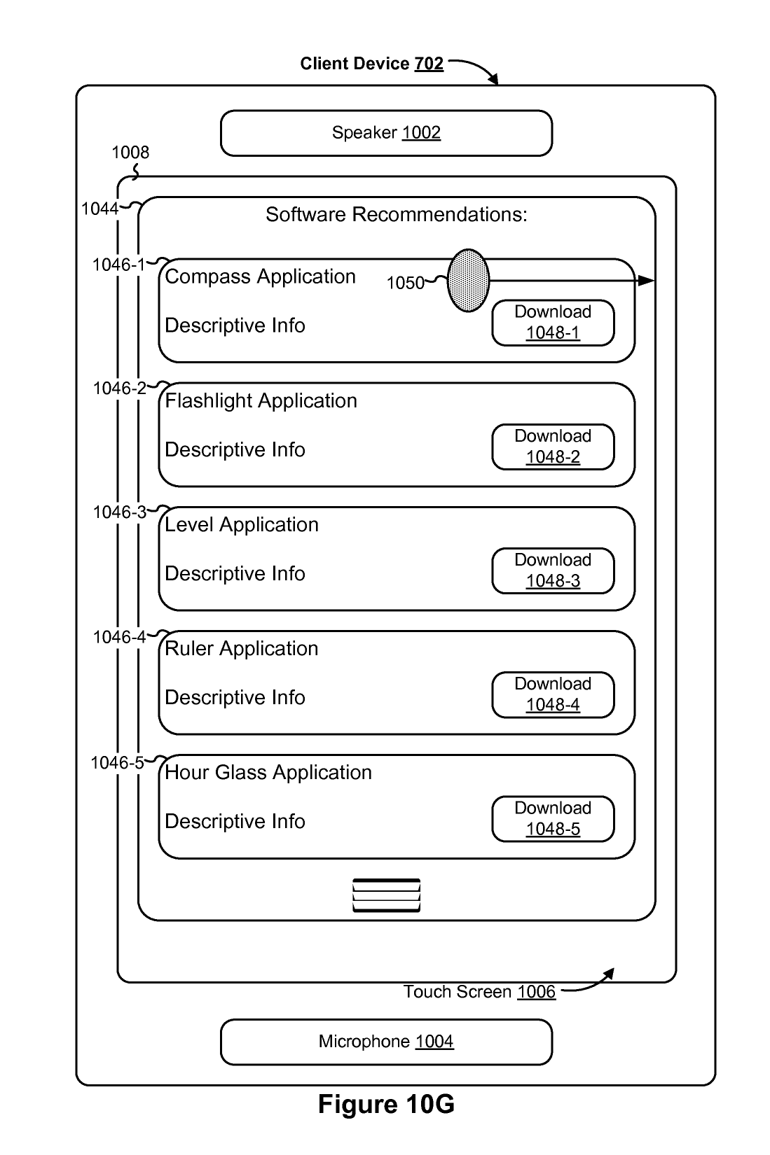

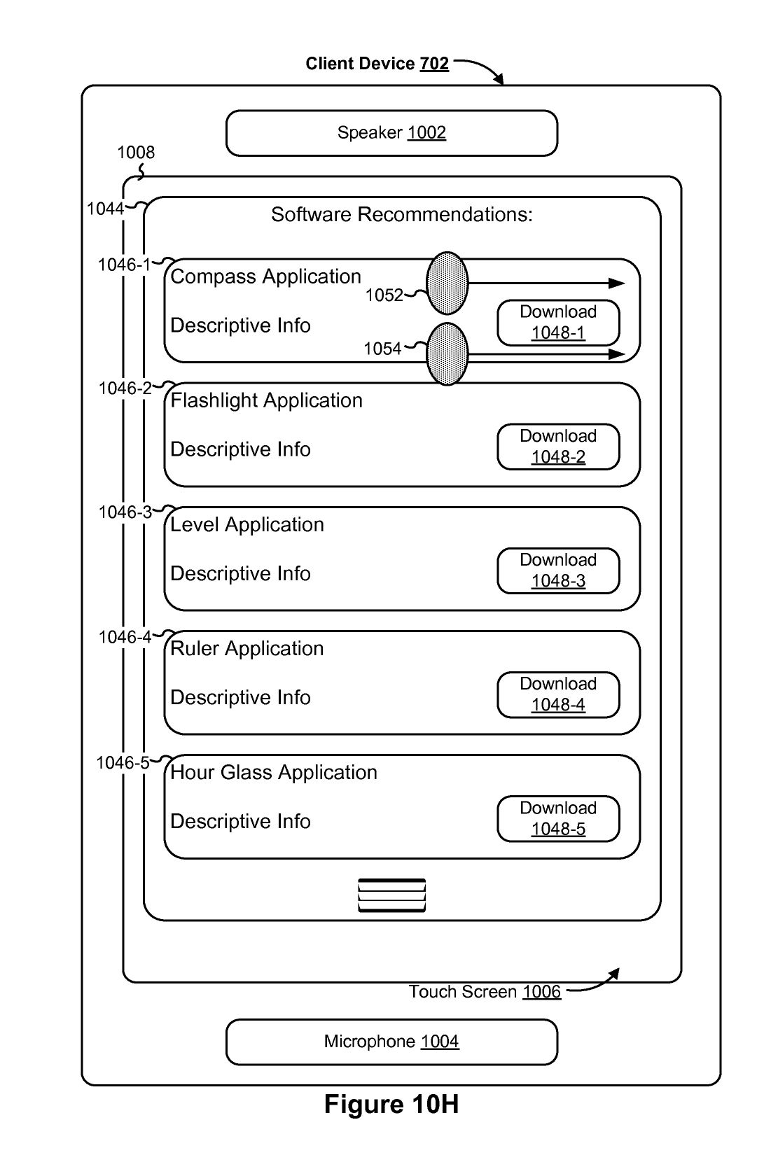

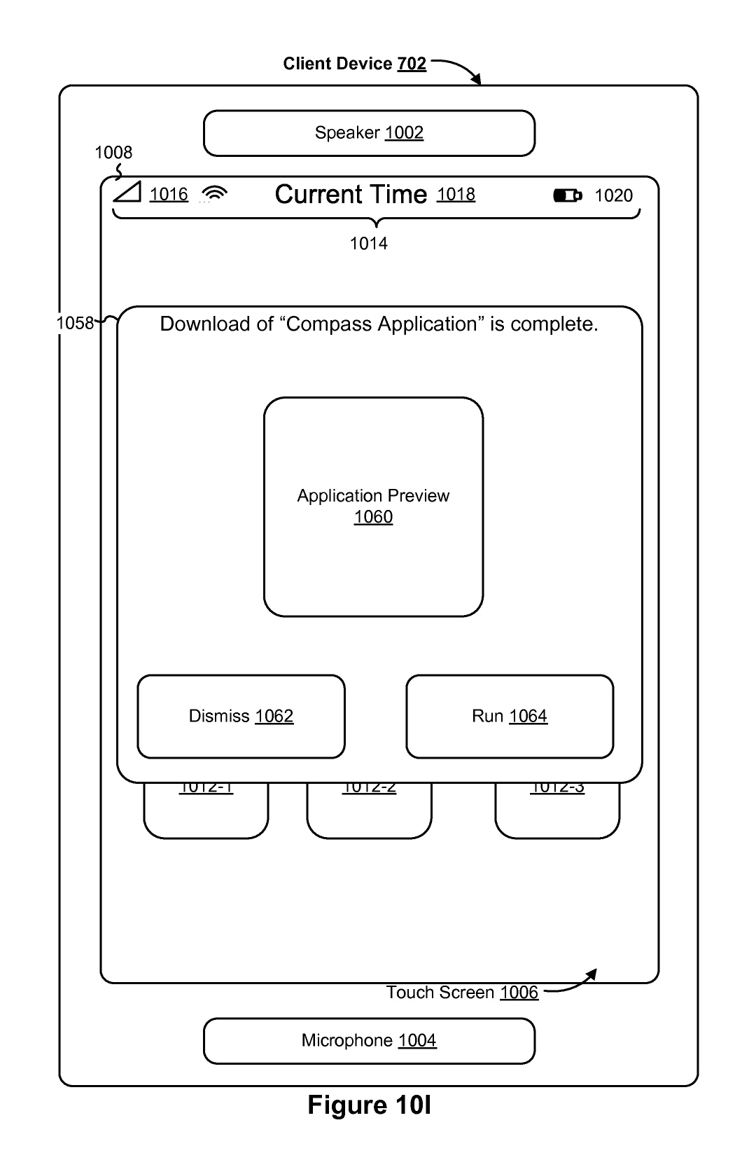

FIG. 8 is a block diagram illustrating a representative client device 702/703 associated with user 701 in accordance with some embodiments. Client device 702/703, typically, includes one or more processing units (CPUs) 802, one or more network interfaces 804, memory 806, and one or more communication buses 808 for interconnecting these components (sometimes called a chipset). Client device 702/703 also includes a user interface 810. User interface 810 includes one or more output devices 812 that enable presentation of media content, including one or more speakers and/or one or more visual displays (e.g., touch screen 1006, FIGS. 10A-10I). User interface 810 also includes one or more input devices 814, including user interface components that facilitate user input such as a keyboard, a mouse, a voice-command input unit or microphone, a touch screen display (e.g., touch screen 1006, FIGS. 10A-10I), a touch-sensitive input pad, a gesture capturing camera, or other input buttons or controls. Furthermore, some client devices 702/703 use a microphone and voice recognition or a camera and gesture recognition to supplement or replace the keyboard. Memory 806 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 806, optionally, includes one or more storage devices remotely located from CPU(s) 702. Memory 806, or alternately the non-volatile memory device(s) within memory 806, includes a non-transitory computer readable storage medium. In some implementations, memory 806, or the non-transitory computer readable storage medium of memory 806, stores the following programs, modules, and data structures, or a subset or superset thereof:
an operating system 816 including procedures for handling various basic system services and for performing hardware dependent tasks;
a network communication module 818 for connecting user device 702/703 to other computers (e.g., server systems 710) via one or more communication network interfaces 804 (wired or wireless) and one or more communication networks 704;
a presentation module 820 for enabling presentation of information (e.g., a user interface for a web page or an application program, audio and/or video content, text, etc.) at client device 702/703 via one or more output devices 812 (e.g., displays, speakers, etc.) associated with user interface 810;
an input processing module 822 for detecting one or more user inputs or interactions from one of the one or more input devices 814 (e.g., touch screen 1006) and interpreting the detected input or interaction; and
one or more client application modules 824 for enabling client device 702/703 to perform corresponding functions, including but not limited to:
   a media application 826 (e.g., a web browser, media player, application program, etc.) for requesting and accessing media content, web pages, and user interfaces for application programs; and
   a software manager application 828 for managing or curating (e.g., updating, downloading, removing, modifying, etc.) a plurality of application programs, software manager application 828 including:
      a recommendation module 830 for requesting and/or receiving recommended software;
      a first condition module 832 for determining whether a first predetermined condition is satisfied;
      a second condition module 834 for determining whether a second predetermined condition is satisfied; and
      a download module 836 for downloading software (e.g., batch downloading software in a favorites folder);
one or more client data modules 838 for storing data related to client device 702/703, including but not limited to:
   a media content buffer 840 for temporarily storing content received from one or more server systems 710;
   a media content database 842 for storing received content as part of user 701's personal library of media content; and
   a user profile 844 for storing context information associated with user 701 of client device 702/703, optionally, including a log of the user interactions with a web browser and/or application programs, web browsing history, location information, the user preferences, behavior and pattern information, and other context information.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 806, optionally, stores a subset of the modules and data structures identified above. Furthermore, memory 806, optionally, stores additional modules and data structures not described above.

FIG. 9 is a block diagram illustrating a representative server system 710 (or, alternatively, server computer 711) in accordance with some embodiments. Server system 710, typically, includes one or more processing units (CPUs) 902, one or more network interfaces 904, memory 906, and one or more communication buses 908 for interconnecting these components (sometimes called a chipset). In some embodiments, memory 906 includes database 712. In some other embodiments, database 712 is located remotely from memory 906 which is located at server computer 711, but database 712 is accessible to server computer 711 and is an aspect of server system 710. Memory 906 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 906, optionally, includes one or more storage devices remotely located from the CPU(s) 902. Memory 906, or alternately the non-volatile memory device(s) within memory 906, includes a non-transitory computer readable storage medium. In some implementations, memory 906, or the non-transitory computer readable storage medium of memory 906, stores the following programs, modules, and data structures, or a subset or superset hereof:
an operating system 910 including procedures for handling various basic system services and for performing hardware dependent tasks;
a network communication module 912 that is used for connecting server system 710 to other computing devices (e.g., client devices 703/703) via one or more network interfaces 904 (wired or wireless) and one or more communication networks 704;
one or more server application modules 914 for enabling server system 710 to perform corresponding functions, including but not limited to:
   a request handling module 916 for receiving requests from client devices 702/703, including requests to login to or access services, web pages, or application programs provided by server system 710 and requests for recommended software;
   one or more software applications 918 (e.g., web-based application programs or software-as-a-service) enabling a user to utilize corresponding services, functions, tools, or media content; and
   a recommendation module 920 for providing a software recommendation notification (e.g., either proactively or in response to a request for recommended software) to a client device, recommendation module 920 includes:
      an identification module 922 for identifying recommended software (e.g., based on a user's profile);
      a context access module 924 for accessing a user profile or other context information associated with a respective user of a client device; and
      a generation module 926 for generating a software recommendation notification (e.g., at least including the name of the recommended software); and
one or more server data modules 928 for storing data related to server system 710, including but not limited to:
   media content database 930 for storing information (e.g., media content, web pages, etc.) and metadata describing the information; and
   a user profile database 932 for storing context information for a plurality of users, where the context information for a respective user, optionally, includes a log of the user interactions with a web browser and/or application programs, web browsing history, location information, the user preferences, behavior and pattern information, and other context information.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 906, optionally, stores a subset of the modules and data structures identified above. Furthermore, memory 906, optionally, stores additional modules and data structures not described above.

Although FIG. 9 shows server system 710, FIG. 9 is intended more as functional description of the various features which may be present in a set of servers than as a structural schematic of the implementations described herein. In practice, and as recognized by those of ordinary skill in the art, items shown separately could be combined and some items could be separated. For example, some items shown separately in FIG. 9 could be implemented on a single server and single items could be implemented by one or more servers. The actual number of servers used to implement server system 710 and how features are allocated among them will vary from one implementation to another.

### User Interfaces and Associated Processes

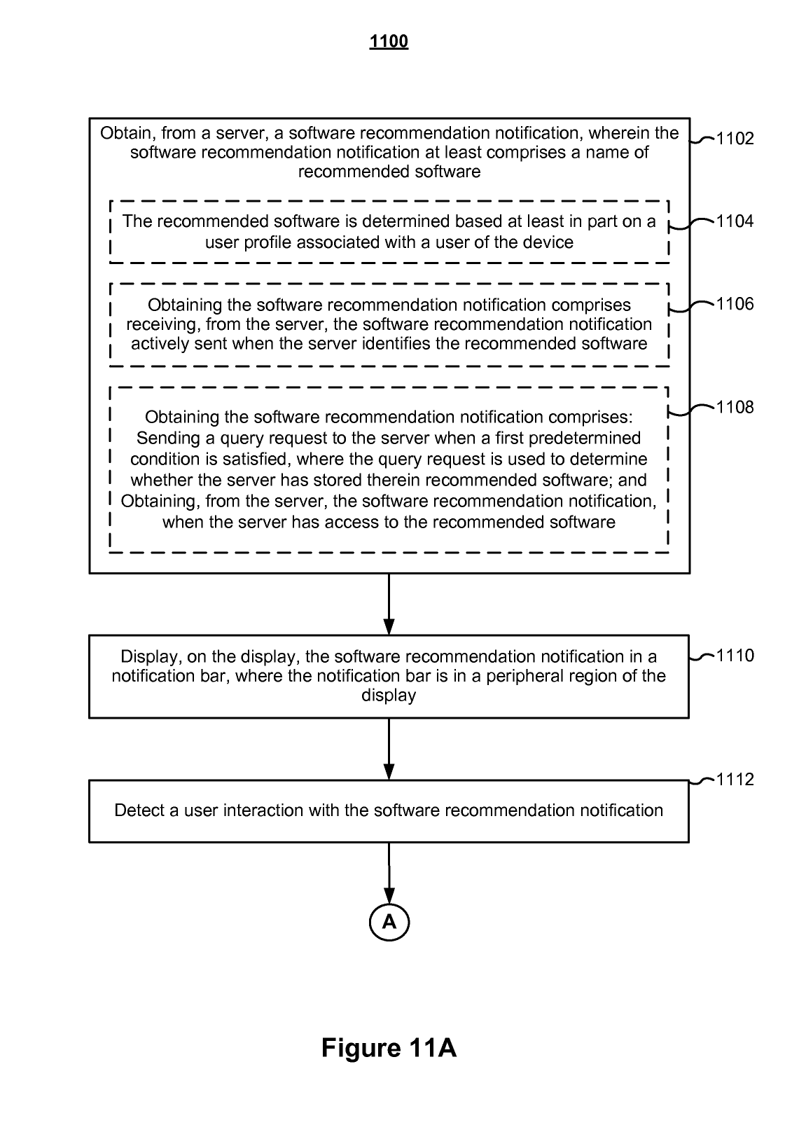

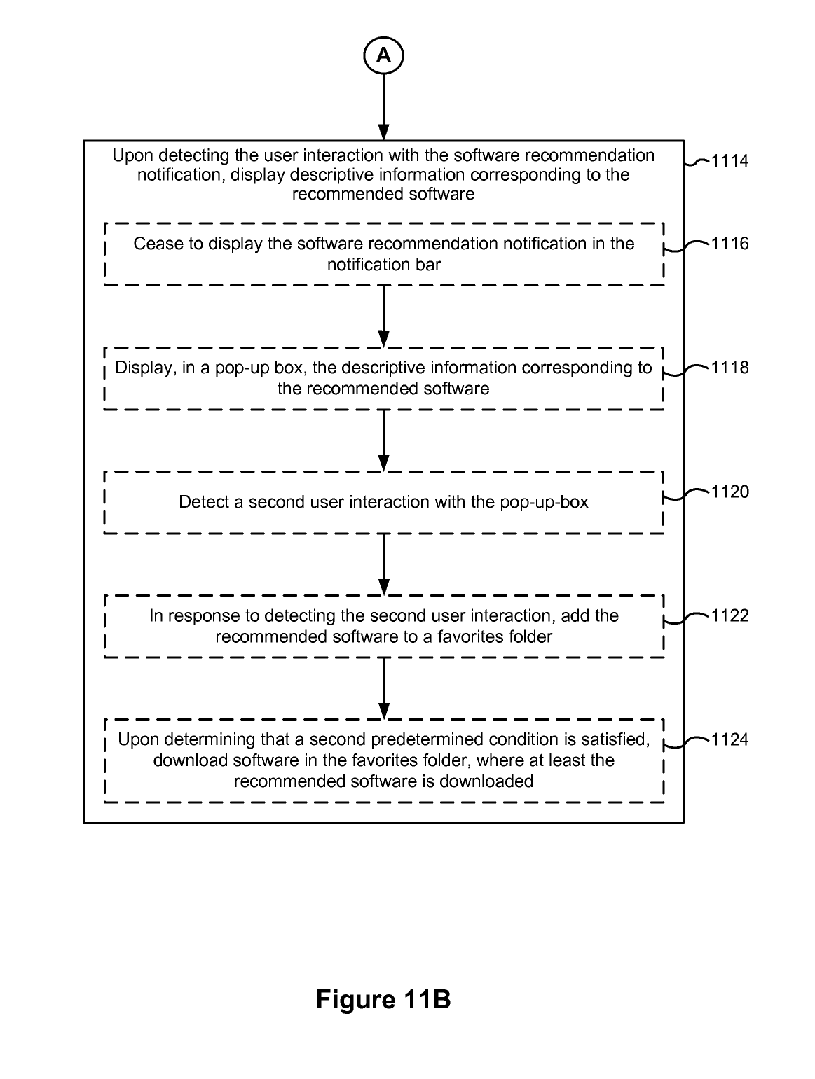

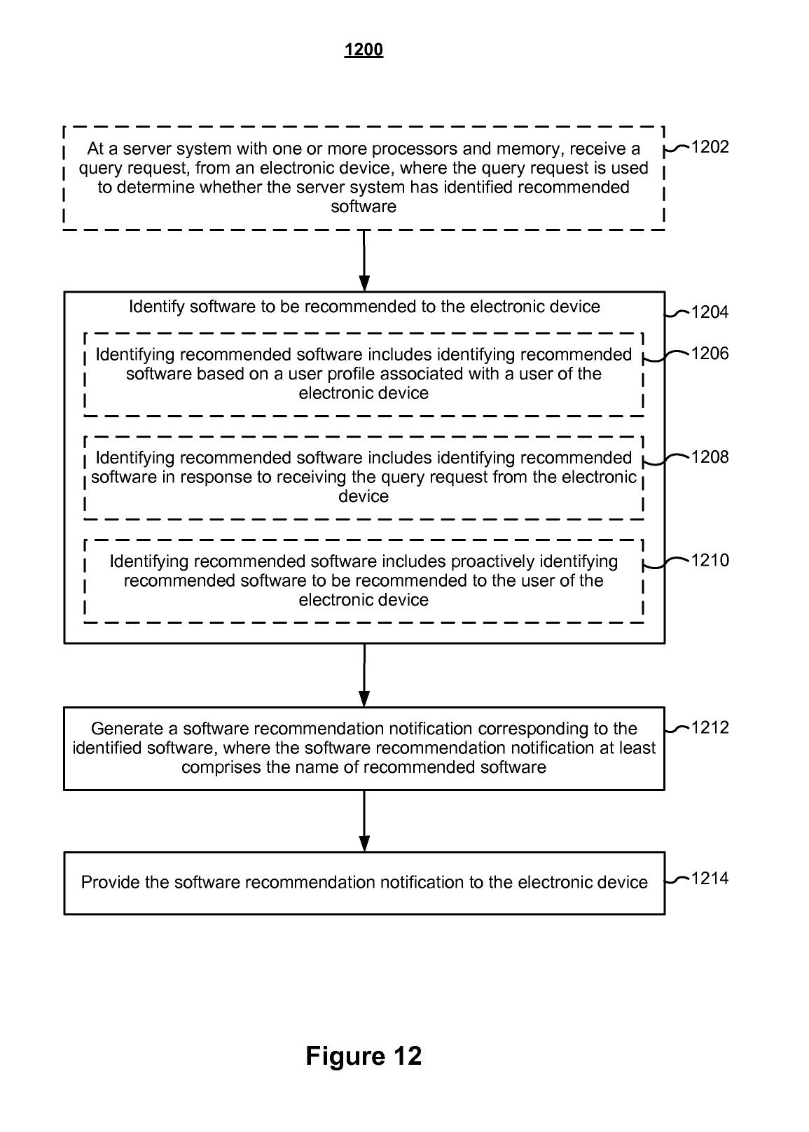

Attention is now directed towards embodiments of user interfaces (“UI”) and associated processes that may be implemented on a respective client device 702/703 with one or more speakers 1002 enabled to output sound, one or more microphones 1004 enabled to receive sound input, and a touch screen 1006 enabled to receive one or more contacts and display information (e.g., media content, web pages and/or user interfaces for application programs). FIGS. 10A-10I illustrate exemplary user interfaces for recommending software in accordance with some embodiments. The user interfaces in FIGS. 10A-10I are used to illustrate the processes described herein, including the processes and systems described above with respect to FIGS. 1-9 and the processes described below with respect to FIGS. 11A-11B and 12. FIGS. 10A-10I show user interface 1008 displayed on client device 702 (e.g., a mobile phone); however, one skilled in the art will appreciate that the user interfaces shown in FIGS. 10A-10I may be implemented on client device 703 (e.g., a laptop) or other similar computing devices. Embodiments 1-4 described above with reference to FIGS. 1-6 provide a basis for the embodiments described below with reference to FIGS. 10A-10I, 11A-11B, and 12.

FIG. 10A illustrates client device 702 displaying a home screen in user interface 1008 of touch screen 1006. In FIG. 10A, user interface 1008 for the home screen includes a plurality of application icons 1010, wherein, each of the application icon, when activated (e.g., by a touch input from a user), causes client device 702 to execute and display a corresponding application program (e.g., a weather application, a media player application, a news aggregator application, a social media application, etc.). In some embodiments, user interface 1008 further includes a plurality of widget icons 1012, wherein, each of the widgets, when activated (e.g., by a touch input from the user), causes client device 702 to execute and display a corresponding widget (e.g., a stock ticker widget, a temperature widget, a calculator widget, etc.). In FIG. 10A, user interface 1008 for the home screen also includes banner 1014 in a top peripheral region of touch screen 1006. For example, banner 1014 includes one or more network communications icons 1016 (e.g., indicating WiFi connectivity or wireless communication signal strength, etc.), current time 1018, and battery life indicator 1020.

FIG. 10B illustrates client device 702 displaying a software recommendation notification 1022 in a top peripheral region of touch screen 1006 (e.g., a notification bar) with a single recommended software (e.g., an application program “Compass”). In some embodiments, software recommendation notification 1022 is displayed in a notification bar, which operates as a push channel. For example, server system 710 is enabled to push notifications (e.g., software recommendations, software updates, new messages or emails, etc.) to client device 702 for display in the notification bar. In some embodiments, the notification bar has display priority over banner 1014 or other user interfaces such as a user interface for an application program or the home screen. In some embodiments, software recommendation notification 1022 is overlaid over banner 1014 (e.g., displayed on touch screen 1006 in FIG. 10A). In some embodiments, client device 702 ceases to display banner 1014 and displays software recommendation notification 1022 in its place. In some embodiments, software recommendation notification 1022 is displayed in a peripheral region other than the top peripheral region (e.g., the bottom or one of the sides of touch screen 1006), and client device 702 maintains display of banner 1014 in the top peripheral region. In FIG. 10B, software recommendation notification 1022 includes the name of the recommended software (e.g., “Compass Application”). In some embodiments, a user input directed to the banner 1014 causes the client device 702 to display a drop-down notification panel that includes the software recommendation notification 1022.

In some embodiments, software recommendation notification 1022 includes additional information related to the recommended software other than the name of the recommended software (e.g., a version number for the recommended software, an estimated download time for the recommended software, etc.). FIG. 10B also illustrates client device 702 detecting contact 1014 (e.g., a tap gesture with the user's finger also called a first user interaction) at a location corresponding to software recommendation notification 1022 on touch screen 1006. As used herein, a software recommendation or recommended software is simply a name of or link to software that is potentially of interest to the user of client device 702. For example, server system 710 provides, to client device 702, software recommendation notification 1022 including a link to software on a website or in an application marketplace.

In some embodiments, when server system 710 identifies recommended software suitable for the user of the client device 702 (e.g., server system 710 identifies that recommended software exists, or server system 710 determines that it has access to or stored therein the recommended software), server system 710 proactively “pushes” or sends software recommendation notifications to client device 702. In some other embodiments, after client device 702 sends a request to server system 710 for recommended software and server system 710 identifies recommended software, client device 702 “pulls” or retrieves recommendation notifications from server system 710. In some embodiments, the user of client device 702 is enabled to disable client device 702 from receiving pushed software recommendation notifications from server system 710.

In some embodiments, server system 710 identifies a plurality of recommended software programs, and, when software recommendation notification 1022 displays a single recommended software, the recommended software displayed in software recommendation notification 1022 is a highest rate or most popular application program or software (e.g., based on ratings or download statistics) of the plurality of recommended software programs. In some other embodiments, server system 710 identifies a plurality of recommended software programs, and, when software recommendation notification 1022 displays a single recommended software, the recommended software displayed in software recommendation notification 1022 is recommended software that is most relevant to the user's interests (e.g., based on a user profile or other context information associated with the user of client device 702) of the plurality of recommended software programs.

FIG. 10C illustrates client device 702 displaying a pop-box 1026 on touch screen 1006 with descriptive information corresponding to the recommended software in response to detecting contact 1014 in FIG. 10B. In FIG. 10C, the descriptive information corresponding to the recommended software in pop-box 1026 includes the name of the recommended software (e.g., “Compass Application”), the name of the software's developer, a user rating for the software, a number of reviews of the software, a size in megabytes of the software, and a price in US dollars of the software. In FIG. 10C, pop-box 1026 also includes a “Dismiss” affordance 1028, which, when activated, causes client device 702 to cease to display pop-box 1026 and software recommendation notification 1022 on touch screen 1006 and a “Download” affordance 1030, which, when activated, causes client device 702 to add the recommended software to a favorites folder (sometimes also herein called a favorites list) for subsequent download. In some embodiments, when activated, “Download” affordance 1030 causes client device 702 to immediately initiate a download of the recommended software or open a uniform resource locator (URL) associated with a web page for the recommended software in a web browser or an application marketplace where the user can download the recommended software. FIG. 10C also illustrates client device 702 ceasing to display software recommendation notification 1022 in the top peripheral region of touch screen 1006 and redisplaying banner 1014 in the top peripheral region of touch screen 1006. FIG. 10C further illustrates client device 702 detecting contact 1031 (e.g., a tap gesture with the user's finger also called a user interaction) at a location corresponding to “Download” affordance 1030 on touch screen 1006. In some embodiments, in response to the detecting contact 1031 (e.g., a second user interaction), client device 702 adds the recommended software (e.g., “Compass Application”) to a favorites folder (sometimes also herein called a favorites list) for subsequent download.

FIG. 10D illustrates client device 702 displaying a software recommendation notification 1032 in a top peripheral region of touch screen 1006 with a plurality of recommended software. In FIG. 10D, software recommendation notification 1032 includes the names of each of the plurality of recommended software programs in separate recommended software boxes 1034. FIG. 10D illustrates first recommended software entitled “Compass Application” in recommended software box 1034-1, second recommended software entitled “Flashlight Application” in recommended software box 1034-2, and third recommended software entitled “Level Application” in recommended software box 1034-3.

In some embodiments, when client device 702 detects a tap gesture at a location corresponding to a respective recommended software box 1034 on touch screen 1006, client device 702 displays descriptive information for the recommended software corresponding to the respective recommended software box 1034. In some embodiments, when client device 702 detects a predetermined removal gesture (e.g., a right-to-left swipe gesture as shown in FIG. 10D, or, alternatively, a left-to-right swipe gesture) at a location corresponding to a respective recommended software box 1034 (e.g. 1034-1) on touch screen 1006, client device 702 removes (or ceases to display) the recommended software corresponding to the respective recommended software box 1034 in software recommendation notification 1032. Based on this removal gesture, the client device optionally notifies the server that the user is not interested in the particular software “Compass Application” recommended by the server. In some embodiments, when client device 702 detects a collection gesture (e.g., a left-to-right swipe gesture as shown in FIG. 10E, or, alternatively, a right-to-left swipe gesture) at a location corresponding to a respective recommended software box 1034 (e.g., 1034-3) on touch screen 1006, client device 702 maintains display of the recommended software corresponding to the respective recommended software box 1034 in software recommendation notification 1032 and adds the recommended software (e.g., the Level Application) corresponding to the respective recommended software box 1034 to a favorites folder for subsequent download. FIG. 10D further illustrates client device 702 detecting the removal gesture (e.g., a right-to-left swipe gesture with contact 1036) at a location corresponding to recommended software box 1034-1 on touch screen 1006.

FIG. 10E illustrates client device 702 ceasing to display recommended software box 1034-1 in software recommendation notification 1032 in response to detecting the removal gesture (e.g., the right-to-left swipe gesture) in FIG. 10D. FIG. 10E also illustrates client device 702 detecting a collection gesture (e.g., the left-to-right swipe gesture with contact 1038) at a location corresponding to recommended software box 1034-3 on touch screen 1006. In response to detecting the collection gesture (e.g., the left-to-right swipe gesture), client device 702 adds the recommended software (e.g., entitled “Level Application”) corresponding to recommended software box 1034-3 to a favorites folder for subsequent download.

FIG. 10F illustrates client device 702 displaying a software recommendation notification 1040 in a top peripheral region of touch screen 1006 (e.g., a notification bar). In FIG. 10F, software recommendation notification 1040 indicates a number of software recommendations available (e.g., five new software recommendations). FIG. 10F also illustrates client device 702 detecting a downward swipe gesture with contact 1042 originating at a location corresponding to software recommendation notification 1040 on touch screen 1006.

FIG. 10G illustrates client device 702 displaying a plurality of software recommendations in a pull-down panel 1044 in response to detecting the downward swipe gesture in FIG. 10F. In FIG. 10G, pull-down panel 1044 includes a plurality of software recommendations each with a respective software recommendation region 1046. First software recommendation region 1046-1 corresponds to recommended software entitled “Compass Application.” Second software recommendation region 1046-2, displayed below first software recommendation region 1046-1, corresponds to recommended software entitled “Flashlight Application.” Third software recommendation region 1046-3, displayed below second software recommendation region 1046-2, corresponds to recommended software entitled “Level Application.” Fourth software recommendation region 1046-4, displayed below third software recommendation region 1046-3, corresponds to recommended software entitled “Ruler Application.” Fifth software recommendation region 1046-5, displayed below fourth software recommendation region 1046-4, corresponds to recommended software entitled “Hour Glass Application.”

Each of the software recommendation regions 1046 includes a respective “Download” affordance 1048, which, when activated, causes client device 702 to add corresponding recommended software to a favorites folder for subsequent download or, alternatively, immediately initiate a download of the recommended software or open a uniform resource locator (URL) associated with a web page for the recommended software in a web browser or an application marketplace where the user can download the recommended software. Each of the software recommendation regions 1046 also includes description information. For example, description information for respective recommended software includes the name of the software's developer, a user rating for the software, a number of review of the software, a size in megabytes of the software, and a price in US dollars of the software.

In some embodiments, when client device 702 detects a removal gesture (e.g., a right-to-left swipe gesture, or, alternatively, a left-to-right swipe gesture) at a location corresponding to a respective software recommendation region 1046 on touch screen 1006, client device 702 removes (or ceases to display) the recommended software corresponding to the respective software recommendation region 1046 in pull-down panel 1044. In some embodiments, when client device 702 detects a collection gesture (e.g., a left-to-right swipe gesture, or, alternatively, a right-to-left swipe gesture) at a location corresponding to a respective software recommendation region 1046 on touch screen 1006, client device 702 maintains display of the recommended software corresponding to the respective software recommendation region 1046 in software pull-down panel 1044 and adds the recommended software corresponding to the respective software recommendation region 1046 to a favorites folder for subsequent download. The download can be automatically started at an appropriate time and/or under appropriate conditions (e.g., bandwidth, processor load conditions, etc.).

In some embodiments, when client device 702 detects a regular collection gesture (e.g., a left-to-right swipe gesture, or, alternatively, a right-to-left swipe gesture) with a single contact at a location corresponding to a respective software recommendation region 1046 on touch screen 1006, client device 702 maintains display of the recommended software corresponding to the respective software recommendation region 1046 in software pull-down panel 1044 and adds the recommended software corresponding to the respective software recommendation region 1046 to a favorites folder for subsequent download. No notification needs to be presented to the user when the download is completed when the user has provided the regular collection gesture. The user can check back to the notification center or the home screen to see if and when the download has been completed. In some embodiments, when client device 702 detects a collection-notification gesture (e.g., a left-to-right swipe gesture, or, alternatively, a right-to-left swipe gesture, with two or more contacts) at a location corresponding to a respective software recommendation region 1046 on touch screen 1006, client device 702 maintains display of the recommended software corresponding to the respective software recommendation region 1046 in software pull-down panel 1044, adds the recommended software corresponding to the respective software recommendation region 1046 to a favorites folder for subsequent download, and proactively displays a completion notification immediately after downloading of the recommended software corresponding to the respective software recommendation region 1046 has been completed. FIG. 10G further illustrates client device 702 detecting a regular collection gesture (e.g., the left-to-right swipe gesture with contact 1050) at a location corresponding to software recommendation region 1046-1 on touch screen 1006. For example, in response to detecting regular collection gesture (e.g., the left-to-right swipe gesture with contact 1050), client device 702 adds the recommended software corresponding to the respective software recommendation region 1046-1 to a favorites folder for subsequent download. client device 702 does not actively notify the user immediately when the download of the software is completed.

FIG. 10H illustrates client device 702 detecting a collection-notification gesture (e.g., the left-to-right swipe gesture with contacts 1052 and 1054) at a location corresponding to software recommendation region 1046-1 on touch screen 1006. For example, in response to detecting the collection-notification gesture (e.g., the left-to-right swipe gesture with contact 1052 and contact 1054), client device 702 adds the recommended software corresponding to the respective software recommendation region 1046-1 to a favorites folder for subsequent download.

FIG. 10I illustrates client device 702 displaying a completion notification 1058 in response to completing download of recommended software corresponding to the respective software recommendation region 1046-1 in FIG. 10H and, also, in response to detecting the collection-notification gesture (e.g., the left-to-right swipe gesture with two or more contacts 1052 and 1054) in FIG. 10H. In some embodiments, completion notification 1058 is immediately displayed and overlaid on the current user interface upon download completion of the recommended software. In some embodiments, completion notification 1058 occupies less than all of touch screen 1006.

In FIG. 10I, completion notification 1058 includes text indicating that “Compass Application” corresponding to the respective software recommendation region 1046-1 in FIG. 10H has been downloaded. In FIG. 10I, completion notification 1058 also includes an application preview 1060 (e.g., a screenshot) of “Compass Application.” In FIG. 10I, completion notification 1058 further includes a “Dismiss” affordance 1062, which, when activated, causes client device 702 to cease displaying completion notification 1058 and a “Run” affordance 1064, which, when activated, causes client device 702 to run or execute the recommended software (e.g., the “Compass Application”) immediately.

FIGS. 11A-11B are flow diagrams illustrating a method 1100 of recommending software in accordance with some embodiments. Method 1100 is performed at an electronic device (e.g., client device 702/703, FIGS. 7-8 sometimes also herein called a client device, a client, or, more simply, a device) with one or more processors, memory, and a display. Some operations in method 1100 are, optionally, combined, and/or the order of some operations is, optionally, changed.

The electronic device obtains (1102), from a server, a software recommendation notification, where the software recommendation notification at least comprises a name of recommended software. For example, prior to displaying software recommendation notification 1022 in FIG. 10B, client device 702 receives, from server system 710, a software recommendation notification 1022 including at least the name of the recommended software. In some embodiments, in addition to the name of the recommended software, software recommendation notification 1022 includes a link to software on a website or in an application marketplace and/or other description information associated with the recommended software.

In some embodiments, the recommended software is determined (1104) based at least in part on a user profile associated with a user of the device. In some embodiments, the user profile includes context information associated with a respective user of a client device (e.g., user 701 of client device 702). For example, the user profile includes a log of user interactions with a web browser and/or application programs (e.g., clicks, deletion, modification, etc.), web browsing history, location history, user preferences, pattern and behavior information, and other such contextual information both hardware and software related. In some embodiments, user profile 844 for a respective user of client device 702 is stored in memory 806 of client device 702. Server system 710 (or, more specially, context access module 924) is enabled to access and collect context information on users. For example, context access module 924 is configured to retrieve user profile 844 from client device 702. In some other embodiments, server system 710 has stored therein a plurality of user profiles in user profile database 932.

After collecting context information (e.g., a user profile) associated with a respective user, server system 710 (or, more specifically, identification module 922) identifies recommended software based on the user profile or other context information. In some embodiments, the recommended software is an application with a higher rating than a previously discarded application of the same type. As an example, Suppose that the user has downloaded a calculator application but deleted the calculator application after a short period of time (e.g., less than 5 days or 1 week). Based on the user's behavior, the server determines that the user is interested in a calculator application, but has not found a particular calculator application that has satisfactory performance or features. Based on this determination, the server optionally determines that the recommended software is another calculator application with a higher user rating than the deleted calculator application. In some embodiments, the recommended software is an application that facilitates an activity recently or frequently undertaken by the user based on a location pattern of the user. As an example, location information indicates that a user frequents wilderness areas or frequently goes backpacking at nearby National Forests, the recommended software includes a compass application, a wildflower identification application, and/or a bird spotting application based on this location pattern and the inferred activities for this location pattern (e.g., hiking, camping, outdoors, etc.). In another example, location information indicates that a user frequents campgrounds, the recommended software includes a flashlight application, a hiking trails application, and/or a campfire stories application based on this location pattern and the inferred activities for this location pattern. In some embodiments, the recommended software is an application that is frequently used by other users when undertaking the same activity as the user or when in the same location as the user. For example, when the server determines a likely activity based on the particular user's location patterns, the server identifies other users having similar location patterns, and software applications that are frequently used by these other users while at these locations. The server optionally recommends these software applications as recommended software for the particular user. In some embodiments, the recommendation is provided to the particular user, when the server determines that the particular user is presently located at these locations. As an example, location information indicates that a user is currently at a local park, the recommended software includes applications used by other users while at the same park or at other parks in the region, or applications used by the user's top contacts (i.e., those contacts that the user communicates most frequently with) while at the same park.

In some embodiments, obtaining the software recommendation notification comprises receiving (1106), from the server, the software recommendation notification actively sent when the server identifies the recommended software suitable for the user. In some embodiments, the server system identifies the recommended software includes by determining that the software that is suitable for the user exists, knowing recommended software exists, having access to the recommended software, and/or having stored therein the recommended software. In some embodiments, server system 710 proactively pushes software recommendations to client device 702/703 upon identifying or inferring that such software will interest the user based on the user profile associated with the user. For example, server system 710 sends client device 702/703 a software recommendation notification for display in the notification bar, which operates as a push channel. In some embodiments, recommendation module 830 is configured to receive the software recommendations from server system 710.

In some embodiments, obtaining the software recommendation notification comprises: sending (1108) a query request to the server when a first predetermined condition is satisfied, where the query request is used to determine whether the server has identified recommended software; and obtaining, from the server, the software recommendation notification, when the server identifies recommended software. In some embodiments, client device 702/703 (or, more specifically, recommendation module 830) sends the query request to server system 710 to determine whether server system 710 has identified recommended software (e.g., the query request operates as an HTTP page request). If server system 710 has identified recommended software, client device 702/703 (or, more specifically, recommendation module 830) pulls (or retrieves) the software recommendation notification from server system 710.

In some embodiments, first condition module 832 is configured to determine whether the first predetermined condition is satisfied. In some embodiments, the first predetermined condition is satisfied when client device 702/703 is connected to a specified network type (e.g., WiFi, 3G, 4G LTE, etc.), when a bandwidth or network speed threshold is met, when a specified amount data remains within the user's monthly data usage allotment, in accordance with a predefined schedule (e.g., every night at midnight), in accordance with a frequency pattern (e.g., every 30 minutes or 1 hr), when a predefined amount of battery life of the client device remains, or when an application meets parameters specified or inferred from a user profile (e.g., any application related to cooking that has a four out of five star rating or better). In some embodiments, user 701 of client device 702/703 is enabled to manually disable client device 702/703 from receiving push notifications or recommendations (e.g., software updates) from the server, and, after disabling the push functionality of client device 702/703, client device 702/703 polls the server for software recommendations when the first predetermined condition is satisfied.

The electronic device displays (1110), on the display, the software recommendation notification in a notification bar, where the notification bar is in a peripheral region of the display. FIG. 10B, for example, shows client device 702 displaying software recommendation notification 1022 in a top peripheral region of touch screen 1006 (e.g., a notification bar) with a single recommended software (e.g., an application program entitled “Compass Application”). FIG. 10D, for example, shows client device 702 displaying software recommendation notification 1032 in a top peripheral region (e.g., a notification bar) of touch screen 1006 with a plurality of recommended software programs.

The electronic device detects (1112) a first user interaction with the software recommendation notification. FIG. 10B, for example, shows client device 702 detecting contact 1014 (e.g., a first user interaction) at a location corresponding to software recommendation notification 1022 on touch screen 1006.

Upon detecting the first user interaction with the software recommendation notification, the electronic device displays (1114) descriptive information corresponding to the recommended software. In some embodiments, the descriptive information at least comprises one or more of an icon of the software, the name of the software, a version number of the software, the size of the software, a function introduction of the software, a download address of the software, and developer information of the software. FIG. 10C, for example, shows client device 702 displaying a pop-box 1026 on touch screen 1006 with descriptive information corresponding to the recommended software in response to detecting contact 1014 (e.g., the first user interaction) in FIG. 10B.

In some embodiments, displaying descriptive information corresponding to the recommended software comprises: ceasing (1116) to display the software recommendation notification in the notification bar; and displaying (1118), in a pop-up box, the descriptive information corresponding to the recommended software. FIG. 10C, for example, shows client device 702 ceasing to display software recommendation notification 1022 in the top peripheral region (e.g., notification bar) of touch screen 1006, redisplaying banner 1014 in the top peripheral region of touch screen 1006, and displaying pop-box 1026 on touch screen 1006 with descriptive information corresponding to the recommended software.

In some embodiments, the electronic device detects (1120) a second user interaction with the pop-up-box (e.g., interaction with a download or collection affordance in the pop-up-box), and, in response to detecting the second user interaction, the electronic device adds (1122) the recommended software to a favorites folder. FIG. 10C, for example, shows client device 702 detecting contact 1031 (e.g., a second user interaction) at a location corresponding to “Download” affordance 1030 in pop-box 1026 on touch screen 1006. In response to the detecting contact 1031, client device 702 adds the recommended software (e.g., “Compass Application”) to a favorites folder for subsequent download.

In some embodiments, upon determining that a second predetermined condition is satisfied, the electronic device downloads (1124) software in the favorites folder, where at least the recommended software is downloaded. In some embodiments, second condition module 834 is configured to determine whether the second predetermined condition is satisfied. In some embodiments, download module 836 is configured to download the software in the favorites folder when second condition module 834 determines that the second predetermined condition is satisfied.

In some embodiments, user 701 of client device 702 is enabled to add, remove, or modify the second predetermined condition. In some embodiments, the second predetermined condition includes two or more parameters that must be all satisfied for the second predetermined condition to be satisfied. In some embodiments, the second predetermined condition includes two or more parameters and only one of the two or more parameters must be satisfied for the second predetermined condition to be satisfied. In some embodiments, the second predetermined condition is satisfied when the device is connected to a designated network or access point (e.g., a user's home WiFi network), when the device is connected to a specified type of network or access point (e.g., WiFi, 3G, 4G LTE, etc.), when a network accessed by the device meets threshold bandwidth and/or speed requirements, when the device is at a specified location (e.g., a coffee shop, internet café, etc.), in accordance with a predefined schedule (e.g., once a week, at the top of every hour, etc.). In some embodiments, client device 702 downloads the software in the favorites folder in batches. For example, if six applications have been added to the favorites folder over the course of a week, when the second determined is satisfied (e.g., the weekly scheduled download time), client device 702 simultaneously downloads all six applications in a batch.

It should be understood that the particular order in which the operations in FIGS. 11A-11B have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., the methods in FIGS. 1-2 and 12) are also applicable in an analogous manner to method 1100 described above with respect to FIGS. 11A-11B.

FIG. 12 is a flow diagram illustrating a method 1200 of recommending software in accordance with some embodiments. Method 1200 is performed at a server system (e.g., server system 710, FIGS. 7 and 9) with one or more processors and memory. Some operations in method 1200 are, optionally, combined, and/or the order of some operations is, optionally, changed.

In some embodiments, the server system receives (1202) a query request, from an electronic device (e.g., client device 702/703, FIGS. 7-8), where the query request is used to determine whether the server system has identified recommended software. In some embodiments, recommendation module 920 is configured to receive a query request from client device 702/703.

The server system identifies (1204) software to be recommended to the electronic device. In some embodiments, identification module 922 is configured to identify recommended software for provision to client device 702/703.

In some embodiments, identifying recommended software includes (1206) identifying recommended software based on a user profile associate with a user of the electronic device. In some embodiments, context access module 924 is enabled to access and collect context information for a plurality of users. For example, context access module 924 is configured to retrieve user profile 844 from client device 702. In some other embodiments, server system 710 has stored therein a plurality of user profiles in user profile database 932. Identification module 922 is the configured identify recommended software for provision to client device 702/703 based on the context information (e.g., a user profile associated with user 701 of client device 702/703) collected by context access module 924.

In some embodiments, identifying recommended software includes (1208) identifying recommended software in response to receiving the query request from the electronic device. In some embodiments, in response to receiving the query request from client device 702/703, identification module 922 is configured to identify recommended software for provision to client device 702/703.

In some embodiments, identifying recommended software includes (1210) proactively identifying recommended software to be recommended to a user of the electronic device. In some embodiments, identification module 922 is configured to proactively identify recommended software for provision to client device 702/703 without prompt or query from client device 702/703. In some embodiments, server system 710 pushes a software recommendation notification with the recommended software to client device 702/703 for display in a notification bar, which operates as a push channel.

The server system generates (1212) a software recommendation notification corresponding to the identified software, where the software recommendation notification at least comprises the name of recommended software. In some embodiments, generation module 926 is configured to generate a software recommendation notification corresponding to the recommended software identified by identification module 922. In some embodiments, the software recommendation notification is formatted for display in a peripheral region of the device.

The server system provides (1214) the software recommendation notification to the electronic device. In some embodiments, network communications module 912 connects server system 710 to one or more communication networks 704 so as to provide the software recommendation notification generated by generation module 926 to client device 702/703.

It should be understood that the particular order in which the operations in FIG. 12 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods and systems described herein (e.g., the methods and systems described in FIGS. 1-11) are also applicable in an analogous manner to method 1200 described above with respect to FIG. 12.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The embodiments were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of recommending software, comprising:
at an electronic device with one or more processors, memory, and a display:
obtaining, from a server, a software recommendation notification, wherein the software recommendation notification at least comprises a name of recommended software;
displaying, on the display, the software recommendation notification in a notification bar, wherein the notification bar is in a peripheral region of the display;
detecting a first user interaction with the software recommendation notification; and
upon detecting the first user interaction with the software recommendation notification, displaying descriptive information corresponding to the recommended software.

2. The method of claim 1, wherein the recommended software is determined based at least in part on a user profile associated with a user of the device.

3. The method of claim 1, wherein obtaining the software recommendation notification comprises:
receiving, from the server, the software recommendation notification actively sent when the server identifies the recommended software.

4. The method of claim 1, wherein obtaining the software recommendation notification comprises:
sending a query request to the server when a first predetermined condition is satisfied, wherein the query request is used to determine whether the server has identified recommended software; and
obtaining, from the server, the software recommendation notification, when the server identifies recommended software.

5. The method of claim 1, wherein displaying descriptive information corresponding to the recommended software comprises:
ceasing to display the software recommendation notification in the notification bar; and
displaying, in a pop-up box, the descriptive information corresponding to the recommended software.

6. The method of claim 5, further comprising:
detecting a second user interaction with the pop-up-box; and
in response to detecting the second user interaction, adding the recommended software to a favorites folder.

7. The method of claim 6, further comprising:
upon determining that a second predetermined condition is satisfied, downloading software in the favorites folder, wherein at least the recommended software is downloaded.

8. An electronic device, comprising:
one or more processors; and
memory;
a display; and
one or more programs, wherein the one or more programs are stored in the memory and configured to be executed by the one or more processors, the one or more programs including instructions that when executed by the one or more processors cause the device to:
obtain, from a server, a software recommendation notification, wherein the software recommendation notification at least comprises a name of recommended software;
display, on the display, the software recommendation notification in a notification bar, wherein the notification bar is in a peripheral region of the display;
detect a first user interaction with the software recommendation notification; and
upon detecting the first user interaction with the software recommendation notification, display descriptive information corresponding to the recommended software.

9. The device of claim 8, wherein the recommended software is determined based at least in part on a user profile associated with a user of the device.

10. The device of claim 8, wherein obtaining the software recommendation notification comprises:
receiving, from the server, the software recommendation notification actively sent when the server identifies the recommended software.

11. The device of claim 8, wherein obtaining the software recommendation notification comprises:
sending a query request to the server when a first predetermined condition is satisfied, wherein the query request is used to determine whether the server has identified recommended software; and
obtaining, from the server, the software recommendation notification, when the server identifies recommended software.

12. The device of claim 8, wherein displaying descriptive information corresponding to the recommended software comprises:
ceasing to display the software recommendation notification in the notification bar; and
displaying, in a pop-up box, the descriptive information corresponding to the recommended software.

13. The device of claim 12, wherein the instructions further cause the device to:
detect a second user interaction with the pop-up-box; and
in response to detecting the second user interaction, add the recommended software to a favorites folder.

14. The device of claim 13, wherein the instructions further cause the device to:
upon determining that a second predetermined condition is satisfied, download software in the favorites folder, wherein at least the recommended software is downloaded.

15. A non-transitory computer readable storage medium storing one or more programs, the one or more programs comprising instructions, which when executed by an electronic device with one or more processors, memory, and a display, cause the device to:
obtain, from a server, a software recommendation notification, wherein the software recommendation notification at least comprises a name of recommended software;
display, on the display, the software recommendation notification in a notification bar, wherein the notification bar is in a peripheral region of the display;
detect a first user interaction with the software recommendation notification; and
upon detecting the first user interaction with the software recommendation notification, display descriptive information corresponding to the recommended software.

16. The non-transitory computer readable storage medium of claim 15, wherein the recommended software is determined based at least in part on a user profile associated with a user of the device.

17. The non-transitory computer readable storage medium of claim 15, wherein obtaining the software recommendation notification comprises:
receiving, from the server, the software recommendation notification actively sent when the server identifies the recommended software.

18. The non-transitory computer readable storage medium of claim 15, wherein obtaining the software recommendation notification comprises:
sending a query request to the server when a first predetermined condition is satisfied, wherein the query request is used to determine whether the server has identified recommended software; and
obtaining, from the server, the software recommendation notification, when the server identifies recommended software.

19. The non-transitory computer readable storage medium of claim 15, wherein displaying descriptive information corresponding to the recommended software comprises:
ceasing to display the software recommendation notification in the notification bar; and
displaying, in a pop-up box, the descriptive information corresponding to the recommended software.

20. The non-transitory computer readable storage medium of claim 19, wherein the instructions further cause the device to:
detect a second user interaction with the pop-up-box;
in response to detecting the second user interaction, add the recommended software to a favorites folder; and
upon determining that a second predetermined condition is satisfied, download software in the favorites folder, wherein at least the recommended software is downloaded.
